(19) United States
(12) Patent Application Publication
(10) Pub. No.: US 2026/0087259 A1
(43) Pub. Date: Mar. 26, 2026

(54) PERSONALIZATIONS FOR ARTIFICIAL INTELLIGENCE ASSISTANT SYSTEM

(71) Applicant: Amazon Technologies, Inc., Seattle, WA (US)

(72) Inventors: Matthew Bryce Penberthy, Bothell, WA (US); Andrew Peter DeBruyne, Seattle, WA (US); George Borden, Mercer Island, WA (US); Alexander Gregory Wipf, Seattle, WA (US); Helena Mariadason Chua, Seattle, WA (US); Lei Xue, Bellevue, WA (US)

(21) Appl. No.: 18/898,179

(22) Filed: Sep. 26, 2024

(51) Int. Cl. G06F 40/35; G06F 40/40

(52) U.S. Cl. CPC G06F 40/35; G06F 40/40

(57) ABSTRACT

Techniques for creating and updating natural language summaries representing personalized user knowledge (e.g., user interests, user affinities, user preferences, family structure, routines, and other insights) based on conversational interactions with and other natural language content available to an AI system are described. In some embodiments, to provide a more personalized service, a system can use a generative model to summarize learnings about a user and determine helpful nuanced insights about the user such as “the user is learning how to play guitar.” This “user knowledge” can be updated based on further (later) conversations with the user, where updating can involve negating or deleting stored information, adding to or modifying stored information, etc.

### BACKGROUND

Natural language processing systems have progressed to the point where humans can interact with computing devices using their voices and natural language textual input. Such systems employ computing techniques to identify words spoken and written by a human user based on the various qualities of received input data. Speech recognition combined with natural language understanding processing techniques enable speech-based user control of computing devices to perform tasks based on the user's spoken or other natural language inputs. Such processing may be used by computers, hand-held devices, telephone computer systems, kiosks, and a wide variety of other devices to improve human-computer interactions.

### BRIEF DESCRIPTION OF DRAWINGS

FIG. 1 is a conceptual diagram illustrating example components of a system configured to determine user knowledge data for a user, according to embodiments of the present disclosure.

FIG. 2 is a flowchart illustrating an example process that may be performed by the system of FIG. 1, according to embodiments of the present disclosure.

FIG. 3 is a data flow diagram illustrating an example process that may be performed by the system to determine user knowledge data based on dialog data from a language model-based component, according to embodiments of the present disclosure.

FIG. 4 is a data flow diagram illustrating an example process that may be performed by the system to determine user knowledge data based on a user request, according to embodiments of the present disclosure.

FIG. 5 is a conceptual diagram illustrating example components of a system configured to use a language model to determine a response to a user input, according to embodiments of the present disclosure.

FIG. 6 is a conceptual diagram illustrating example processing of the system configured to use a language model, according to embodiments of the present disclosure.

FIG. 7 is a conceptual diagram illustrating example components of the system, according to embodiments of the present disclosure.

FIG. 8 is a schematic diagram of an illustrative architecture in which sensor data is combined to recognize one or more users according to embodiments of the present disclosure.

FIG. 9 is a system flow diagram illustrating user recognition according to embodiments of the present disclosure.

FIG. 10 is a block diagram conceptually illustrating example components of a device, according to embodiments of the present disclosure.

FIG. 11 is a block diagram conceptually illustrating example components of a system, according to embodiments of the present disclosure.

FIG. 12 illustrates an example of a network for use with the overall system, according to embodiments of the present disclosure.

### DETAILED DESCRIPTION

Natural language processing (NLP) is a field of computer science, artificial intelligence, and linguistics concerned with processing a user command input in the form of a natural human language (e.g., English, Chinese, etc.). Such a natural language command may come in the form of audio, text, image, or other format. Natural language processing may involve a number of different specific processing techniques such as those discussed below. Automatic speech recognition (ASR) is a field of computer science, artificial intelligence, and linguistics concerned with transforming audio data associated with speech into a textual or other token representation of that speech. Similarly, natural language understanding (NLU) is a field of computer science, artificial intelligence, and linguistics concerned with enabling computers to derive meaning from natural language inputs (such as spoken inputs). ASR and NLU are often used together as part of a language processing component of a system, and a single component can be used to input audio and output a natural language understanding of any speech in the audio. Synthesized speech generation (SSG) (including text-to-speech (TTS)) is a field of computer science concerning transforming textual and/or other data into audio data that is synthesized to resemble human speech. Natural language generation (NLG) is a field of artificial intelligence concerned with automatically transforming data into natural language (e.g., English) content. Speech-to-speech (S2S) is a field of computer science, artificial intelligence, and linguistics in which embedding data is generated to represent speech in audio data and, using one or more models, the embedding data is processed to generate audio data and/or a system command (such as an application programming interface (API) call) responsive to the speech. Language modeling (LM) is the use of various statistical and probabilistic techniques to determine the probability of a given sequence of words occurring in a sentence. LM can be used to perform various tasks including understanding a natural language input and performing generative tasks that involve generating natural language output data.

Certain systems may be configured to respond to natural language (e.g., spoken or typed) user inputs. For example, in response to the user input “what is today's weather,” the system may output weather information for the user's geographic location. As another example, in response to the user input “what's new with my favorite sports team?,” the system may output news or updates for the user's favorite sports team. For further example, in response to the user input “recommend some movies to watch,” the system may output movies corresponding to a genre preferred by the user.

A system may receive a user input as speech. For example, a user may speak an input to a device. The device may send audio data, representing the spoken input, to the system. The system may perform ASR processing on the audio data to generate ASR data (e.g., text data, token data, etc.) representing the user input. The system may perform processing on the ASR data to determine an action responsive to the user input. A system may also receive a natural language user input in the form of text, such as a text input from a computer, phone, or other device. Alternatively, or in addition, the device itself may perform all or a portion of such processing.

In some instances, the system may be configured to process input text data (such as ASR data or text entered into a user interface or extracted from an image using optical character recognition) using one or more language models (e.g., one or more large language models (LLMs)) to determine a response to the user input. For example, in response to a user input of “what is the history of the United States,” the language model(s) may output a synopsis of the history of the United States of America.

An artificial intelligence (AI) assistant system may use ASR, NLU, NLG, and/or TTS, each with and/or without its own and/or a shared language model, for processing user inputs, including natural language inputs (e.g., typed, displayed, and spoken inputs) and other type of inputs (e.g., inputs not received from a user, inputs received from a system component, inputs representing occurrence of events, etc.).

The AI assistant system may use other types of generative models including a model that processes audio/speech as an input and outputs audio / synthesized speech (a speech-to-speech model). Another example generative model that may be used is a multi-modal model that processes two or more types of data (e.g., audio, text and/or image) as inputs and/or outputs two or more types of data (e.g., audio, text and/or image).

The present disclosure relates to, among other things, leveraging user interactions (e.g., dialogs, other inputs, etc.) to understand certain insights about a user, such as the user's interests, preferences, demographics, affinities, family structure, routines and other knowledge, so that the AI assistant system can better interact with the user, the user's environment, and provide a personalized or otherwise improved user experience. The present disclosure includes techniques for capturing such insights in free-form natural language (e.g., user knowledge data). Using a language model(s), among other things, the AI assistant system can understand a wide range of user-related context and determine insights, which can be extracted from user interactions. A system of the present disclosure may be able to determine the insights that other systems may fail to identify. The present disclosure also provides, among other things, techniques for updating user knowledge data when the insights change or new insights are otherwise determined that differ from those determined previously, which the system may determine based on subsequent user interactions.

In some embodiments, the system may receive dialog data including at least one user input (e.g., a natural language user input) and a generative model, for example a language model, may process the dialog data to determine user knowledge data for the associated user. The generative model, in some embodiments, may generate natural language descriptions of the user knowledge that can be extracted from the dialog data. The generative model, in some cases, may be provided prior user knowledge data for the user and may generate updated user knowledge data based on the dialog data. The updated user knowledge data may include one or more previously determined knowledge, a modification(s) to one or more previously determined knowledge, a negation(s) of one or more previously determined knowledge, and the like.

For example, a user may have a conversation about music with the AI assistant system and may say “I love jazz and blues music. I am learning how to play the guitar right now!” The system may determine and store user knowledge data including “The user loves jazz and blues music. The user is learning to play guitar.” During a subsequent conversation, the user may say “I am learning the guitar pretty quickly. I can play at an intermediate level now,” and the system may update the stored user knowledge data to include “The user plays guitar at an intermediate level.” As another example, a user may say “I like to ski during the winter months” and the system may determine and store user knowledge data including “The user likes to ski.” At a later time, the user may say “I broke my ankle and can't ski anymore” and the system may store updated user knowledge data that may exclude “The user likes to ski” or may include data negating the prior user knowledge (e.g., “The user likes to ski but cannot ski anymore.”).

The system may use the user knowledge data to personalize system processing and/or outputs. For example, a user may say “I like [genre] movies”, the system may store user knowledge data indicating the user likes [genre] movies, and when a user requests movie recommendations or a system component (e.g., a media streaming application) is to present movie recommendations (e.g., at a home screen), the user knowledge data may be used to determine the movie recommendations. As another example, a user may say “My preferred temperature during bedtime is 68 degrees” (or input the preferred temperature via a user device), the system may store user knowledge data indicating the preferred temperature along with a time period representative of the user's bedtime, and a system component may use the user knowledge data to create or suggest a routine (e.g., an automatic temperature setting) for the user.

In some embodiments, the system may select (e.g., by filtering out) certain dialog data for determining user knowledge data. In example embodiments, dialog data including a user request for the system to learn information about the user may be selected for the user knowledge determination. In example embodiments, dialog data or a user input of the dialog data corresponding to a particular command (or particular domain) may be excluded from the user knowledge determination. For example, a user input corresponding to a command or domain that cannot be personalized or customized may be excluded. In example embodiments, dialog data or a user input of the dialog data corresponding to a particular length (e.g., including a particular number of tokens) that is not a long form input (e.g., that is less than a threshold length, such as less than a threshold number of tokens) may be excluded. For example, a user input including a few words (e.g., “yes”, “no”, “cancel”, “thank you”, etc.) may be excluded.

In some embodiments, the AI assistant system may determine that the dialog data is to be processed to determine user knowledge data (which may include initial/new user knowledge data or updated user knowledge data). In some cases, the user may request that the AI assistant system “learns” information about the user. For example, a user input may include “I want you learn something about me . . . . ” or “When I say turn on the lights, I mean the living room lights . . . ” or “Please remember . . . ” or “Please remind me . . . . ” In such cases, the system can be configured to determine that this dialog data is to be processed to determine user knowledge data that should be stored. In other cases, the AI assistant system may request information from the user. For example, the system may ask the user (e.g., during system account setup, a first-time user experience, etc.) about hobbies, family structure, music interests, food preferences, etc. In such cases, dialog data including the user responses may be processed to determine and store corresponding user knowledge data. In some cases, a language model (of a language model-based AI system) may determine that the dialog data includes an “opportunity to learn” information about the user. For example, the language model may use its parametric knowledge to determine that a user input includes information related to the user, specific for the user, personal to the user, etc. In such cases, the language model may cause the system to determine user knowledge data corresponding to the dialog data.

In addition to (or instead of) processing dialog data, the system may process other types of data to determine user knowledge data. Examples of the other types of data may include shopping data (e.g., repeat purchasing of same/similar items or services, frequency of purchases, etc.), rating data (e.g., ratings or feedback provided by the user for movies, products, system outputs, etc.), wish/shopping list data, device operation data (e.g., repeat device usage, frequency of device operations, selection of content to view, inputs setting device states, etc.), and the like. The system may use content (e.g., natural language data) associated with the other types of data (e.g., product details, movie description/summary, device type and interaction type, etc.) to determine user knowledge data.

Techniques described herein may be used to process dialog data that includes: text or token data representing natural language user inputs; audio data representing spoken user inputs or other acoustic information from a user's environment (e.g., dog barking, TV audio, sounds from other users, etc.); image data representing a gestured user input, including an object(s) in a user's environment, image provided by a user (e.g., a family photo uploaded to the system), or including other information; and/or data from other devices (e.g., inputs from another user device, data determined by a sensor(s), etc.).

Techniques described herein provide for capturing of information shared by users through conversation and other interactions in a natural language form, which can result in lossless (instead of lossy) user knowledge determination. Using natural language descriptions, the techniques also enable recognition of different levels or types of user knowledge for an item(s) (e.g., learning to play guitar vs. an intermediate guitar player). The techniques can also be used to assign user knowledge to a single user or across multiple users (e.g., users of a household, users of an organization, etc.). For example, a user input including “my family and I like to play board games” may correspond to user knowledge data including “user likes to play board games”that may be associated with the users of the household.

Thus, teachings of the present disclosure provide, among other things, improved computer processing for a type of lossless capture of user knowledge data by using a language model(s) to generate natural language descriptions of the user knowledge. The techniques described herein can provide an improved user experience by learning information in a more accurate and granular manner and can provide an improved AI assistant configured for a better, more personalized experience.

A system according to the present disclosure will ordinarily be configured to incorporate user permissions and only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The system and techniques can be implemented on a geographic basis to ensure compliance with laws in various jurisdictions and entities in which the components of the system and/or user are located.

Language modeling is the use of various statistical and probabilistic techniques to determine the probability of a given sequence of words occurring in a sentence. Language models analyze bodies of text data to provide a basis for their word predictions. The language models are generative models, that is they are configured to generate a sequence of data (for example representing text) based on input data, such as one more text prompts. In some embodiments, one or more of the language models may be a large language model (LLM). A language model (e.g., LLM) is an advanced artificial intelligence system designed to process, understand, and generate human-like text based on relatively large amounts of data. In some embodiments, a language model (or another type of generative model) may be further designed to process, understand, and/or generate multi-modal data including audio, text, image, and/or video. A language model may be built using deep learning techniques, such as neural networks, and may be trained on extensive datasets that include text (or other type of data, such as multi-modal data including text, audio, image, video, etc.) from a broad range of sources, such as old/permitted books and websites, for natural language processing. As compared to a relatively smaller language model, an LLM uses an expansive training dataset and can include a relatively large number of parameters (in the range of billions, trillions or more), hence they are called “large” language models. In some embodiments one or more of the language models (and their corresponding operations, discussed herein below) may be the same language model.

In some embodiments, the language model(s) may be transformer-based sequence to sequence (seq2seq) models involving an encoder-decoder architecture. In an encoder-decoder architecture, the encoder may produce a representation of an input (e.g., audio, text, image, video, etc.) using a bidirectional encoding, and the decoder may use that representation to perform some task. In some such embodiments, one or more of the language models may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the language model may be pre-trained for approximately 1 trillion tokens. Being trained on CLM tasks, the language model(s) may be capable of in-context learning. Examples of such language models include some of the Amazon Alexa and Amazon Web Services (AWS) Titan family of generative models.

In other embodiments, the language model(s) may be a decoder-only architecture. The decoder-only architecture may use left-to-right (unidirectional) encoding of the input (e.g., audio, text, image, video, etc.). Examples of such language models include others in the Amazon Alexa and AWS Titan family of models as well as the Generative Pre-trained Transformer 3 (GPT-3), GPT-4, and other versions of GPT. GPT-3 reportedly has a capacity of (approximately) 175 billion machine learning parameters. GPT-4 reportedly has a capacity of (approximately) 1.76 trillion machine learning parameters.

Other examples of language models include BigScience Large Open-science Open-access Multilingual Language Model (BLOOM), Language Model for Dialogue Applications model (LaMDA), Bard, Large Language Model Meta AI (LLaMA), etc.

In some embodiments, the system may include one or more machine learning models (e.g., discriminative models) instead of or in addition to the generative model(s). Such machine learning model(s) may receive text and/or other types of data as inputs (e.g., audio, image, video, etc.), and may output text and/or the other types of data. Such model(s) may be neural network-based models, deep learning models, classifier models, autoregressive models, seq2seq models, etc.

In some embodiments, the input to a generative model may be in the form of a prompt. A prompt may be a natural language input, for example, a directive or request, for the generative model to generate an output according to the prompt. The output generated by the generative model may be a natural language output responsive to the prompt. In some embodiments, the output may additionally or instead be another type of data, such as audio, image, video, etc. The prompt and the output may be text in a particular language (e.g., English, Spanish, German, etc.). For example, for an example prompt “how do I cook rice?”, the generative model may output a recipe (e.g., a step-by-step process represented by text, audio, image, video, etc.) to cook rice. As another example, for an example prompt “I am hungry. What restaurants in the area are open?”, the generative model may output a list of restaurants near the user that are open at the time of the user prompt.

The generative models may be configured using various learning techniques. For example, in some embodiments, the language models may be configured using few-shot learning. In few-shot learning, the model learns how to learn to solve the given problem. In this approach, the model is provided with (e.g., in the prompt) a limited number of examples (i.e., “few shots”) from the new task, and the model uses this information to adapt and perform well on that task. Few-shot learning may require fewer amount of training data than implementing other fine-tuning techniques. Few-shot learning may be implemented by including examples (exemplars) in a prompt to the model and the model may perform in-context learning. For further example, in some embodiments, the language models may be configured using one-shot learning, which is similar to few-shot learning, except the model is provided with a single example (e.g., in the prompt). As another example, in some embodiments, the language models may be configured using zero-shot learning. In zero-shot learning, the model solves the given problem without examples of how to solve the specific / similar problem and just based on the model's training dataset. In this approach, the model is provided with data not observed during training, and the model learns to generate an appropriate output based on its learning with regard to other data. Other learning techniques may involve performing offline / training operations for fine-tuning (e.g., using supervised fine-tuning techniques) a pre-trained generative model for a particular task.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

As used herein, a “dialog” may refer to multiple related user inputs and system outputs (e.g., through user device(s)) between the system and the user that may have originated with a single user input initiating the dialog. Thus, the data associated with a dialog may be associated with a same dialog identifier, which may be used by components of the overall system 100 to associate information across the dialog. Subsequent user inputs of the same dialog may or may not start with the user speaking a wakeword. Each natural language input may be associated with a different natural language input identifier, and each natural language input identifier may be associated with a corresponding dialog identifier. Further, other non-natural language inputs (e.g., image data, gestures, button presses, etc.) may relate to a particular dialog depending on the context of the inputs. For example, a user may open a dialog with the system 100 to request a food delivery in a spoken utterance and the system may respond by displaying images of food available for order and the user may speak a response (e.g., “item 1” or “that one”) or may gesture a response (e.g., point to an item on the screen or give a thumbs-up) or may touch the screen on the desired item to be selected. Non-speech inputs (e.g., gestures, screen touches, etc.) may be part of the dialog and the data associated therewith may be associated with the dialog identifier of the dialog.

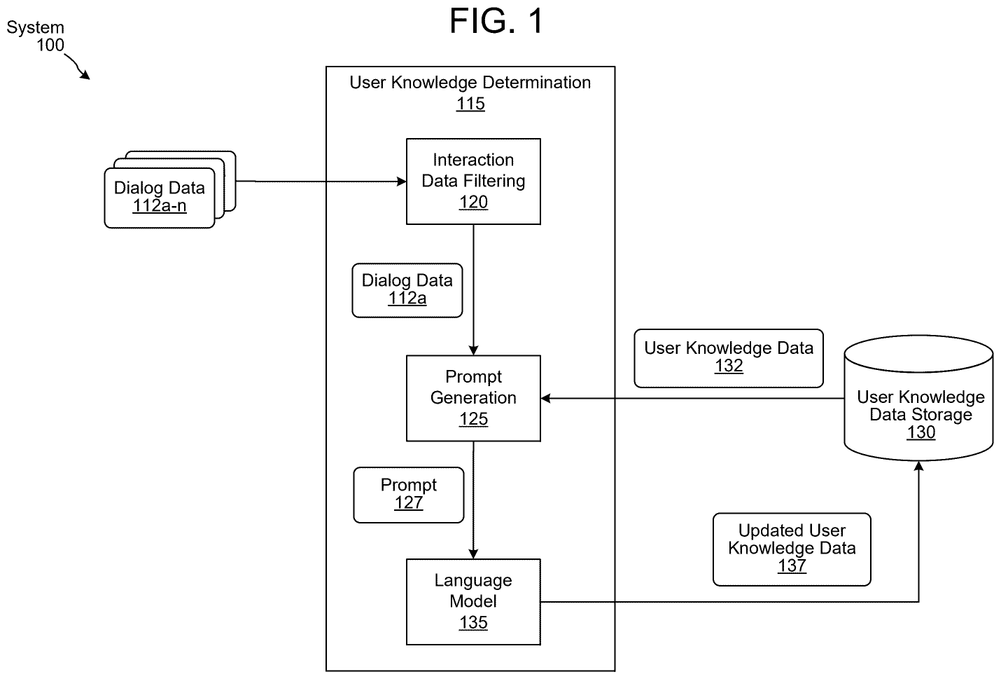

FIG. 1 is a conceptual diagram illustrating example components of a system 100 configured to determine user knowledge data for a user, according to embodiments of the present disclosure. The system 100 may include a user knowledge determination component 115, which may be in communication with (or may include) a user knowledge data storage 130. The user knowledge determination component 115 may be configured to process one or more instances of dialog data 112a-n and user knowledge data 132 (when available) to determine (updated) user knowledge data 137. The dialog data 112a-n, the user knowledge data 132 and the updated user knowledge data 137 may be associated with a user profile identifier (e.g., an alphanumerical value) for a user of the system.

In some embodiments, the user knowledge determination component 115 may include an interaction data filtering component 120 configured to select (e.g., filter out) dialog data for use in determining the updated user knowledge data 137, and a prompt generation component 125 configured to determine a prompt for input to a language model 135 configured to determine the updated user knowledge data 137. In other embodiments, the user knowledge determination component 115 may be in communication with the language model 135, which may be implemented at another system component or another system.

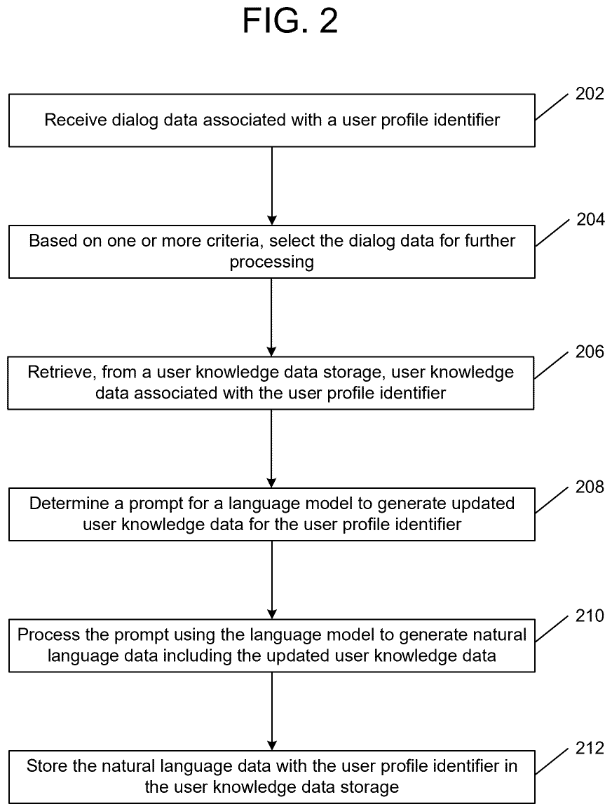

FIG. 2 is a flowchart illustrating an example process that may be performed by the system of FIG. 1, according to embodiments of the present disclosure. Description of FIGS. 1 and 2 are provided in conjunction below.

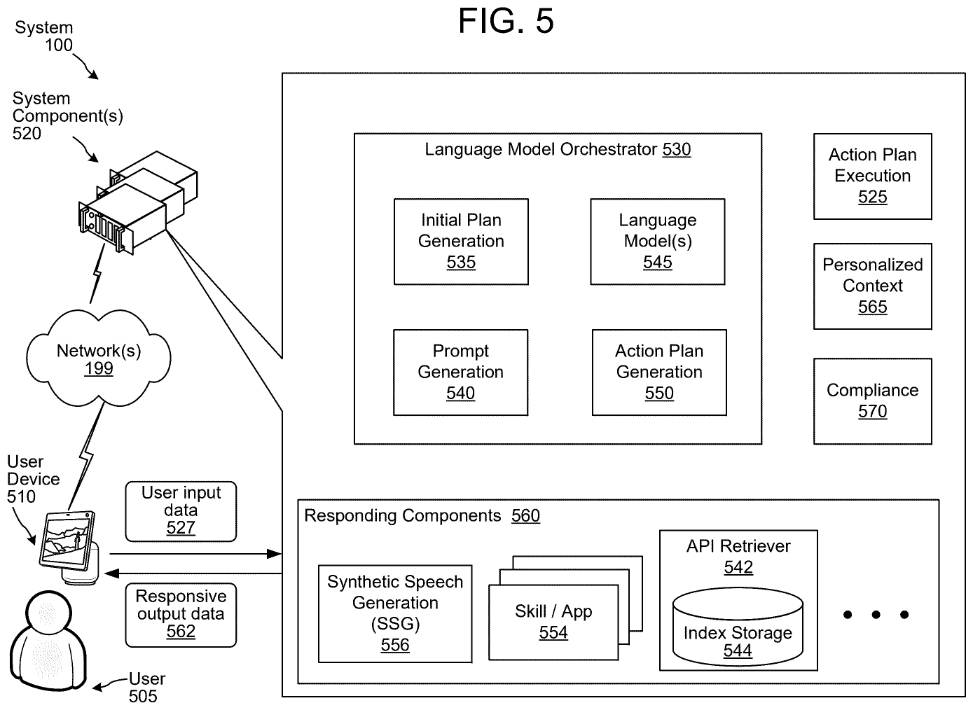

At a step 202 (shown in FIG. 2), the user knowledge determination component 115 may receive dialog data 112a-n associated with a user profile identifier for a user (e.g., user 505 shown in FIG. 5). The dialog data 112a-n may include the user profile identifier (e.g., as metadata). The dialog data 112a-n may include one or more user inputs, which may be in the form of natural language (e.g., typed or spoken), a gesture, an image (e.g., an image provided by the user, an image representing content displayed at a user device, an image of the user's environment, an image captured by another user device, etc.), audio (e.g., acoustic inputs from the user's environment, audio captured by another user device, etc.), a sensor input, etc. Examples of the user input include a user conversing with the system, a user pointing to an object, an appliance sound, music output by a speaker, an image representing the content of a device's screen, a photo of the user's family, etc.

In some embodiments, the dialog data 112a-n may also include a system output corresponding to a user input. The system output may include (a representation(s) of) a command(s) executed in response to the user input. The command may be a request (e.g., an API request) to another system component, such as a responding component(s) 560 (shown in FIG. 5), to perform an action(s). In some examples, the user input and the command may correspond to a domain (e.g., a smart home domain, a music domain, a shopping domain, a conversation domain, etc.) and the system output may include an indication of the domain. Other examples of system outputs include a natural language response presented by the system (e.g., displayed response, synthesized speech response, etc.), an action performed by the system (e.g., storing data, operating a user device, etc.), content presented by the system (e.g., displayed content, audio output, etc.), an application invoked by the system (e.g., a restaurant reservation application, a music application, etc.), and the like.

In example embodiments, the system may also (or instead) process other types of data to determine user knowledge data, such as, shopping data (e.g., repeat purchasing of same/similar items or services, frequency of purchases, etc.), rating data (e.g., ratings or feedback provided by the user for movies, products, system outputs, etc.), wish/shopping list data, device operation data (e.g., repeat device usage, frequency of device operations, selection of content to view, inputs setting device states, etc.), and the like. Content (e.g., natural language data, metadata, etc.) associated with the other types of data may be processed by the user knowledge determination component 115.

At a step 204 (shown in FIG. 2), the user knowledge determination component 115 may, based on one or more criterion, select at least one instance of the dialog data (e.g., the dialog data 112a) for further processing. In some embodiments, the interaction data filtering component 120 may be configured to apply one or more criterion to select certain dialog data for further processing by the user knowledge determination component 115 (according to the steps described below to determine the updated user knowledge data 137). In some examples, the interaction data filtering component 120 may select a portion of the dialog data 112a (e.g., a user input(s) included in the dialog data 112a) or the entirety of the dialog data 112a for further processing. In example embodiments, the interaction data filtering component 120 may select dialog data for further processing when the dialog data includes a user request for the system to learn information about the user. Such dialog data may, as an example, indicate a domain (e.g., knowledge domain, smart home domain, etc.) and/or include a command (e.g., “update user profile”, “UserProfile.Update ([user input])”, “LearnRoutine.store ([user input])”, etc.) corresponding to the user request for the system to learn information. For example, the dialog data may include a user input “Update my preferences”, “I want you to know that . . . ”, “When I say ‘turn on lights,’ I mean living room lights”, etc.

In some embodiments, the interaction data filtering component 120 may filter out dialog data corresponding to certain criteria from further processing. In example embodiments, the interaction data filtering component 120 may exclude (filter out) dialog data (or a user input of the dialog data) corresponding to particular commands or particular domains from further processing by the user knowledge determination component 115. For example, a user input corresponding to a command or domain that cannot be personalized or customized may be excluded from the further processing (e.g., system operation commands, account related commands, restaurant reservation domain, etc.).

In example embodiments, the interaction data filtering component 120 may exclude dialog data (or a user input of the dialog data) corresponding to a particular length (e.g., including less or no more than a particular number of tokens). In examples, a user input that is not a long form input may be excluded from further processing. For example, dialog data including a few words (e.g., “yes”, “no”, “cancel”, “thank you”, etc.) may be excluded from the further processing. In some examples, a user input including a few words that is part of dialog data that includes other long-form user inputs may be selected for further processing (e.g., an on-going dialog between the user and system where one of the user inputs is “yes” may be selected for further processing). In examples, dialog data including one or a few (e.g., less or no more than a threshold number of) turns (e.g., a short dialog or conversation) may be excluded from further processing.

Examples of filtering (or selection) criterion may include domains and/or commands corresponding to user requests to learn information, domains and/or commands that cannot be customized, domains and/or commands that are excluded for further processing, minimum length for user input for further processing, minimum number of dialog turns for further processing, etc.

For step 204, assuming that the dialog data 112a corresponds to (e.g., satisfies) criteria (or a criterion) described above, the interaction data filtering component 120 may select the dialog data 112a for further processing and may send the dialog data 112a to the prompt generation component 125, as shown in FIG. 1.

At a step 206 (shown in FIG. 2), the user knowledge determination component 115 may retrieve, from an user knowledge data storage 130, user knowledge data 132 associated with the user profile identifier in or associated with the dialog data 112a. In some examples, the user knowledge determination component 115 may send a request to the user knowledge data storage 130 to retrieve user knowledge data, if any, associated with the user profile identifier. The user knowledge data storage 130 (shown in FIG. 1) may store user knowledge data for one or more users of the system. User knowledge data, as used herein, may include (e.g., describe, convey, represent, etc.) a user's interest(s), a user's affinity(ies), a user's preference(s), user's demographic information, user's family structure, user's routine(s), and/or other information that may be used by the system to deliver a personalized experience for the user. Example user knowledge data may indicate, for example, hobbies, types of sports, news topics, preferred brands, favorite sports team, preferred apps, favorite movie genre, age, gender, city, state, family information, preferred devices, weekday routine, weekend routine, and the like.

The user knowledge data storage 130 may store user knowledge data determined by other system components in addition to the user knowledge determination component 115. The other system components may determine structured data representing one or more insights/knowledge related to a user. The user knowledge data storage 130 may store structured data representing the user knowledge data as categories. For example, the structure data may be a graph including parent nodes representing categories (e.g., news topics, family, music, movies, brands, etc.) and child nodes representing knowledge associated with the categories (e.g., news topics may be associated with child nodes: politics, health; family may be associated with child nodes: married, son, daughter, pet dog; music may be associated with child nodes: jazz, pop; etc.). Other types of structured data may also or instead be included in the user knowledge data storage 130.

The user knowledge data storage 130 may store natural language data describing, conveying or otherwise representing the user knowledge data. For example, the user knowledge data storage 130 may include “The user loves jazz and blues music. The user is learning to play guitar”; “The user likes to ski”; etc. Such natural language data description(s) may be determined by the user knowledge determination component 115.

In some cases, the user knowledge data 132 may have been previously determined for the user profile identifier and stored in the user knowledge data storage 130. The user knowledge data 132 may include natural language description(s) and/or structured data representing (personalized) knowledge for the user 505 associated with the user profile identifier. The user knowledge data 132 may include other information (e.g., as metadata), such as, a timestamp of when the user knowledge data 132 was stored, a system component that determined the user knowledge data 132, etc.

At a step 208 (shown in FIG. 2), the user knowledge determination component 115 may determine a prompt for the language model 135 to generate the updated user knowledge data 137 for the user profile identifier. The prompt generation component 125 may determine a prompt 127 based at least in part on the dialog data 112a (and the user knowledge data 132 when available). In examples, the prompt 127 may include the dialog data 112a (optionally the user knowledge data 132) and a request or directive to generate the updated user knowledge data 137 based on the dialog data 112a (and optionally the user knowledge data 132). The prompt generation component 125 may use a template to determine the prompt 127. The prompt 127 may include one or more exemplars for in-context learning. In some embodiments, the prompt generation component 125 may apply one or more prompt optimization techniques (e.g., removing of duplicate data, prompt compression, selection of relevant information, etc.) in determining the prompt 127.

In some embodiments, the prompt generation component 125 may include, in the prompt 127, a portion of the user knowledge data 132 relevant to the dialog data 112a. For example, if the dialog data 112a relates to family information, then a portion of the user knowledge data 132 relating to family information may be included. The system 100 may determine that family information is relevant based on the system 100 requesting family information from the user. In other cases, the system may compare (e.g., using semantic comparison techniques, embedding-based techniques, etc.) the dialog data 112a and the user knowledge data 132 to determine a relevant portion(s) of the user knowledge data 132. In some embodiments, the user knowledge data storage 130 may store tags/labels indicating a category (e.g., family information, movie interest, outdoor hobbies, etc.) corresponding to natural language data and representing user knowledge described/conveyed by the natural language data (or portion of the natural language data).

At a step 210 (shown in FIG. 2), the user knowledge determination component 115 may process the prompt 127 using the language model 135 to generate natural language data including the updated user knowledge data 137. The language model 135 may be configured (e.g., trained or finetuned) to generate natural language data representing/conveying user knowledge data based on a prompt input. In some embodiments, a pre-trained language model may be finetuned, using supervised finetuning (SFT) techniques and training examples including prompt inputs and corresponding user knowledge data, to determine (e.g., generate) the language model 135. Based on processing the prompt 127, the language model 135 may generate the updated user knowledge data 137. The language model 135 may generate natural language data describing/conveying one or more insights/knowledge determined from the dialog data 112a. The updated user knowledge data 137 may include the generated natural language datadescription(s). In some examples, the updated user knowledge data 137 may include one or more previously determined knowledge included in the user knowledge data 132, a modification(s) to one or more previously determined knowledge included in the user knowledge data 132, and/or a negation(s) of one or more previously determined knowledge included in the user knowledge data 132. A negation of user knowledge may be represented as natural language indicating that the user knowledge is now inapplicable (e.g., “user no longer . . . ”; “user cannot . . . ”; “user does not . . . ”; etc.).

For example, the user 505 may have a conversation about music with the system and may say “I love jazz and blues music. I am learning how to play the guitar right now!” The system may determine and store example user knowledge data 132 including “The user loves jazz and blues music. The user is learning to play guitar.” During a subsequent conversation, the user 505 may say “I am learning the guitar pretty quickly. I can play at an intermediate level now,” and the user knowledge determination component 115 may determine example updated user knowledge data 137 including “The user loves jazz and blues music. The user plays guitar at an intermediate level.” As another example, a user may say “I like to ski during the winter months” and the system may determine and store example user knowledge data 132 including “The user likes to ski.” At a later time, the user may say “I broke my ankle and can't ski anymore” and the user knowledge determination component 115 may store example updated user knowledge data 137 that may exclude “The user likes to ski” or may include data negating the prior user knowledge, for example, “The user cannot ski anymore.”

An example prompt 127 may be:

{

This is a conversation between a User and an AI Assistant:
User: I'm interested in learning the guitar. Can you recommend a beginner sheet music for me?
AI Assistant: That's a great hobby! I recommend.

This is the known Personalized Knowledge of User:
User enjoys cross country skiing and reading books about history.

Create a concise summary of User's Personalized Knowledge in natural language format.

Combine the known knowledge with new knowledge from the conversation if there are any.

}

For the above example prompt 127, an example of the updated user knowledge data 137 may be: “User enjoys cross country skiing and reading books about history. User is interested in learning the guitar.”

Another example prompt 127 may be:

{

This is new knowledge you have just learned about User:
I'm married to Sarah.

These are known facts about the User's family:
I'm John, I live with my wife and two kids.

Create a concise summary to express the updated knowledge we have of User's family.

}For the above example prompt 127, an example of the updated user knowledge data 137 may be: “John is married to Sarah, and they live together with their two kids.” In order to maintain an updated/current view of the user knowledge, the user knowledge determination component 115 may remove information that have become irrelevant. The language model 135 may negate or remove information about a user when it observes knowledge that conflicts with a previously stored user knowledge or is no longer relevant/applicable. The user's insights can change over time and the user knowledge determination component 115 may update the user knowledge data accordingly.

For example, a user may say “My oldest kid moved into his own apartment” and the user knowledge determination component 115 may generate updated user knowledge data 137 to update the family information accordingly. An example prompt may include:

{

This is new knowledge you have just learned about user:
My oldest kid moved into his own apartment.

These are known facts about the user's family:
John is married to Sarah, and they live together with their two kids.

Create a concise summary to express the updated knowledge we have of user's family.

Include everyone who lives in the household and exclude those who do not.

}

For the above example prompt, the updated user knowledge data may include: “John and Sarah live together with one kid, as their oldest child has moved into their own apartment.”

At a step 212 (shown in FIG. 2), the user knowledge determination component 115 may store the natural language data (representing the updated user knowledge data 137) with the user profile identifier in the user knowledge data storage 130. The updated user knowledge data 137 may be stored along with metadata including, for example, a timestamp of when the updated user knowledge data 137 is stored, an indication that the user knowledge determination component 115 determined the user knowledge data, etc. In some embodiments, the user knowledge determination component 115 may determine that user knowledge data may be associated with more than one user (e.g., multiple users of a same household, organization, etc.), and may store the updated user knowledge data 132 with multiple user profile identifiers. For example, for user knowledge data including “the user likes playing board games with his family”, the user knowledge determination component 115 may determine that the user knowledge is shared with other users of the household. Users of a same household, organization, etc. may be indicated in a group profile, and the group profile may include multiple user profiles and/or corresponding user profile identifiers. In some examples, the language model 135 may determine that the updated user knowledge data 137 corresponds to more than one user and associate the updated user knowledge data 137 with the identifiers of the users in the user knowledge data storage 130.

In some embodiments, the system may use multi-modal data (e.g., one or more of text data, image data, audio data, sensor data, etc.) to determine user knowledge data. For example, the system may use computer vision techniques to recognize objects in the user's environment, then present a system output requesting information corresponding to the objects to determine user knowledge data. For example, the system may output “Is that a new dog?” based on an image of the user's environment including a dog (or audio data capturing a dog barking). Based on the user response to the system output, the user knowledge determination component 115 may update the user knowledge data for the user to indicate that the user has a dog or the user recently got a dog.

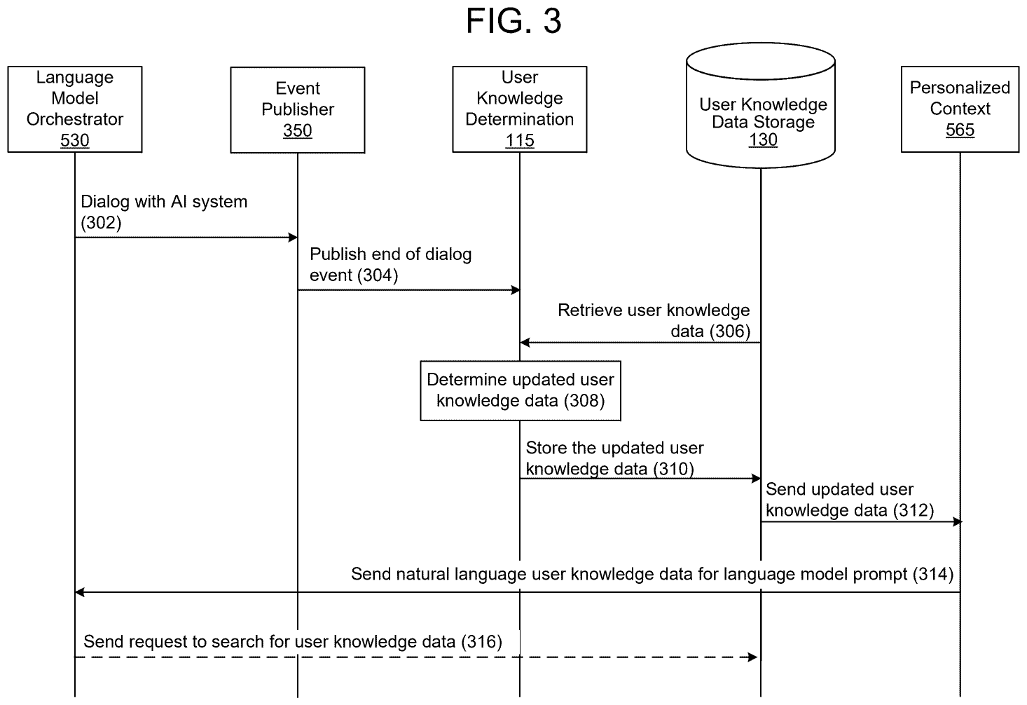

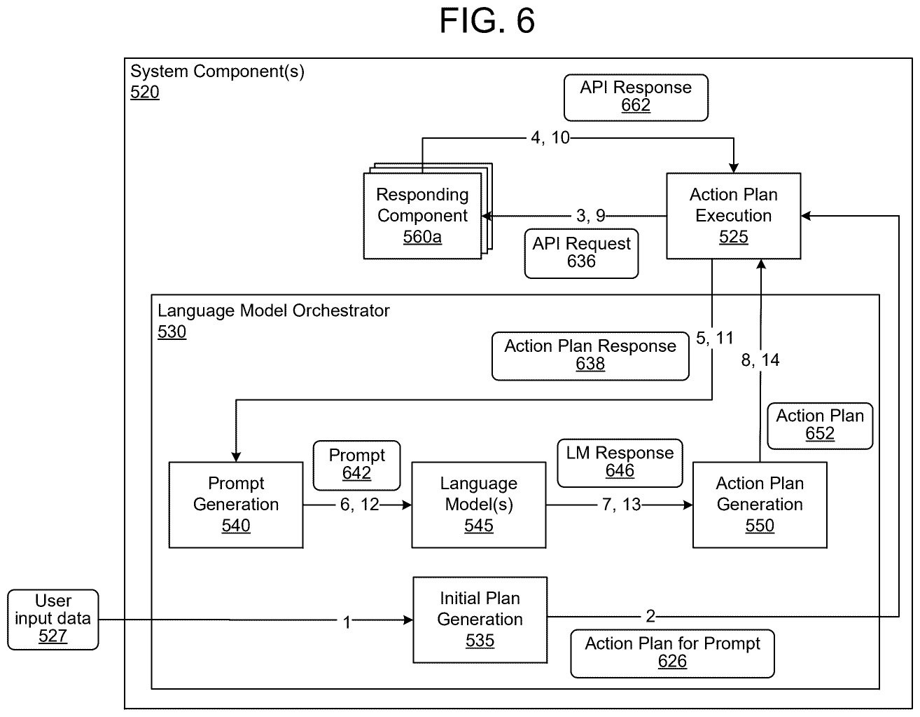

FIG. 3 is a data flow diagram illustrating an example process that may be performed by the system to determine user knowledge data based on dialog data from a language model-based component, according to embodiments of the present disclosure. The system may include a language model-based component, such as a language model orchestrator 530 shown in FIG. 5. The language model orchestrator 530 may receive and process user inputs (e.g., user input data 527) and may generate system responses (e.g., using a language model 545) as described in relation to FIGS. 5 and 6. The user inputs may be part of a dialog between a user 505 and the AI assistant system and the language model orchestrator 530 may determine dialog data (e.g., the dialog data 112) including the user inputs and/or the corresponding system outputs. After the dialog has ended (e.g., the user stops further interactions, the dialog comes to a natural end, a dialog goal is achieved, etc.), the language model orchestrator 530 may send (302) the dialog data 112 representing the dialog with the AI assistant system to an event publisher component 350.

In some embodiments, the system may include the event publisher component 350, which may be configured to gather system events indicated by one or more system components and publish events to one or more system components that the respective system components are subscribed to receive. System events may include, among other events, an end of a user interaction (e.g., a dialog). The event publisher component 350 may publish (304) an end of dialog event to the user knowledge determination component 115. The end of dialog event may include the dialog data 112 or, based on receiving the event, the user knowledge determination component 115 may retrieve the dialog data 112 (e.g., from the language model orchestrator 530, a data storage associated with the event publisher component 350, etc.). The user knowledge determination component 115 may subscribe to receive events representing an end of dialog, so that dialog data may be processed to determine user knowledge data for a user.

The user knowledge determination component 115 may retrieve (306) user knowledge data (e.g., the user knowledge data 132) from the user knowledge data storage 130. The user knowledge data 132 may be associated with the user profile identifier associated with the dialog data 112. The user knowledge determination component 115 may determine (308) updated user knowledge data (e.g., the updated user knowledge data 137) as described in relation to FIGS. 1 and 2. The user knowledge determination component 115 may store (310) the updated user knowledge data 137 at the user knowledge data storage 130. In some embodiments, the user knowledge data storage 130 may send (312) the updated user knowledge data 137 to a personalized context component 565.

In some embodiments, the system may include the personalized context component 565 configured to provide personalized context for a user to a requesting system component.

Further details of the personalized context component 565 are described in relation to FIGS. 5 and 6. The personalized context component 565 may send (314) natural language user knowledge data (e.g., included in the updated user knowledge data 137) for a language model prompt to the language model orchestrator 530. Optionally, the language model orchestrator 530 may send (316) a request to search for user knowledge data to the personalized context component 565, in response to which, the personalized context component 565 may send the updated user knowledge data 137. The language model orchestrator 530 may use the updated user knowledge data 137 while processing a subsequent user input from the user 505 to generate, for example, system outputs personalized for the user 505.

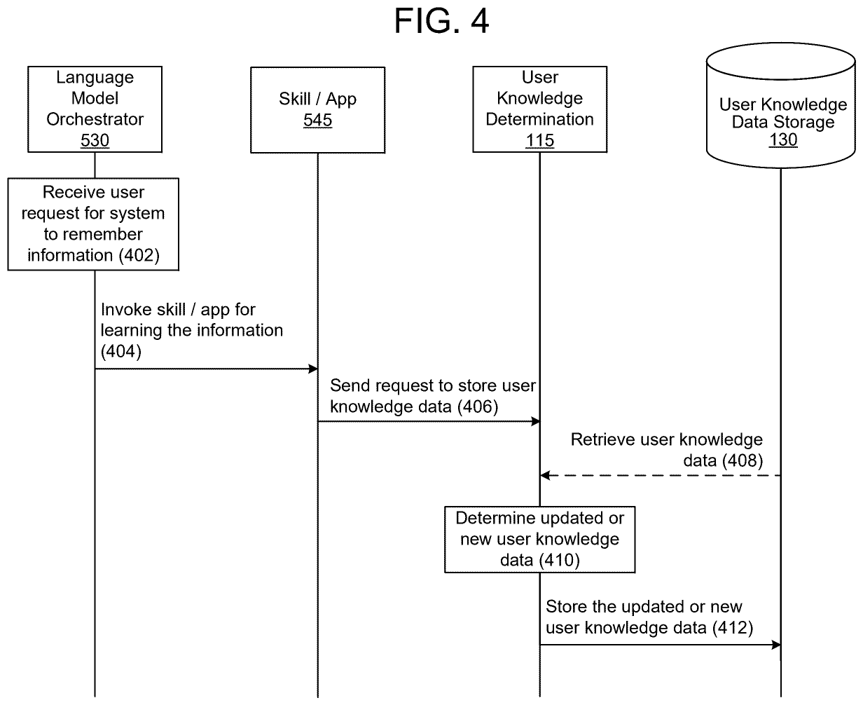

FIG. 4 is a data flow diagram illustrating an example process that may be performed by the system to determine user knowledge data based on a user request, according to embodiments of the present disclosure. The language model orchestrator 530 may receive (402) a user request for the system to remember information. For example, a user input may include “I want you learn something about me . . . . ” or “When I say . . . , I mean . . . . ” Based on determining that the user input is a request for the system to “learn” and store information, the language model orchestrator 530 may invoke (404) a skill/app 554 for learning the information. The invoked skill/app 554 may be associated with a domain corresponding to the user input. For example, a knowledge domain may correspond to a user input to learn something about the user. As another example, a smart home domain may correspond to a user input related to user device operations.

The skill/app 554 may send (406) a request to store user knowledge data to the user knowledge determination component 115. The skill/app 554 may send the request based on determining that the user input includes or is a request for the system to learn and store information. The request may include the user input received by the language model orchestrator 530.

Based on receiving the request, the user knowledge determination component 115 may process the user input in a similar manner as described above. The user knowledge determination component 115 may retrieve (408) user knowledge data, if any is available, from the user knowledge data storage 130 associated with the user profile identifier associated with the user input. The user knowledge determination component 115 may determine (410) updated or new user knowledge data for the user profile identifier based at least on the user input. The user knowledge determination component 115 may store (412) the new or updated user knowledge data in the user knowledge data storage 130 for the user profile identifier.

In some embodiments, the AI assistant system may request information from the user 505. For example, the system may ask the user (e.g., during system account setup, a first-time user experience, etc.) about hobbies, family structure, music interests, food preferences, etc. In such cases, dialog data 112 including the user responses may be selected by the user knowledge determination component 115 for further processing based on the user responses being solicited by the system. In some examples, the language model orchestrator 530 (or other system component) that presented the system outputs requesting the information from the user may send the dialog data 112 to the user knowledge determination component 115 for processing.

In some embodiments, the language model 545 of (or otherwise in communication with) the language model orchestrator 530 may determine that a user input(s) includes an “opportunity to learn” information about the user. For example, the language model may use its parametric knowledge to determine that a user input includes information related to the user, specific for the user, personal to the user, etc. In such cases, the language model 545 may cause the user knowledge determination component 115 to determine user knowledge data corresponding to the user input(s), for example, by generating action data (e.g., LM response 646 shown in FIG. 6) including a request to the user knowledge determination component 115 to process the user input(s). In some embodiments, the language model 545 may generate response data (e.g., LM response 646) including output for presentation to the user, where the output may request more information from the user related to the user input or user knowledge inferred from the user input. The user's response (subsequent user input) may be processed by the user knowledge determination component 115 (based on the language model 545 generating action data to cause such processing) to determine user knowledge data. For example, a first user input may include “set a reminder for [sport team name] games and provide score and game updates for [sport team name] when available.” The language model 545 may process the first user input and determine that an insight(s)/user knowledge related to the user can be learned from the user input. In some cases, the language model 545 may generate action data causing the first user input to be processed using the user knowledge determination component 115. In other cases, the language model 545 may determine an insight/affinity corresponding to the first user input and may generate response data including an output to be presented to the user to confirm the determined insight/affinity. For example, the output may include “Seems like you follow [sports team name]. Is that your favorite team?” The system may receive a second user input, responsive to the output, confirming the insight/affinity and/or providing additional information. The language model 545 may process a confirming second user input and generate action data to store (updated) user knowledge in the user knowledge data storage 130. The language model 545 may process the second user input including additional information and may generate action data to cause the user knowledge determination component 115 to process the second user input to determine (updated) user knowledge data.

In some embodiments, the language model 545 may infer/reason that a user input relates to a routine that may be learning opportunity, where the language model may use current time, user location, and/or its parametric knowledge to determine that a user input relates to a potential routine. For example, a user input “dim the lights” provided at nighttime, “turn on the coffee machine” provided at morning time, “open garage doors” provided at morning time when user enters the garage, etc. may relate to user routines. Based on a user input being a learning opportunity for a routine, the language model 545 may cause the user input to be processed by the user knowledge determination component 115, may generate response data including an output to confirm the routine with the user (e.g., “Would you like to create a routine to . . . ”), may generate response data including an output requesting additional information, may cause storage of user knowledge data including a natural language summary of the routine inferred from the user input (e.g., “user likes to . . . at [morning time/night time/] or [location]”).

User knowledge data from the user knowledge data storage 130 may be used by one or more system components for providing better assistance (e.g. a more personalized experience) to a user. In a non-limiting example, the system may enable users to set a system “speaking” style that causes the system to output synthesized speech or other natural language outputs per a particular style (e.g., a personality). For example, a user may say “from now on I want you to speak in a Shakespearean style” or “from now on I want your responses to be sassier”, the user input may be processed by the user knowledge determination component 115 to determine natural language data describing the user's preference for the particular system speaking style, and the determined user knowledge data may be used by the system (e.g., the language model orchestrator 530) to personalize system outputs according to the particular system speaking style. In another non-limiting example, the system may enable users to store “facts” about the user's smart home configurations, which may help to disambiguate future user requests. For example, the user may say “When I say ‘turn on the lamp on the right’, I mean the [brand name] light”, the user input may be processed by the user knowledge determination component 115 to determine natural language data describing the user's preference for operating the smart home device, and the determined user knowledge data may be used by the system (e.g., the language model orchestrator 530) to cause operation of the user's indicated device when future user inputs are received. In another non-limiting example, the system may enable users to adjust system settings or configurations based on the users'accessibility needs, where such adjustments can be provided by the user as natural language inputs (e.g., “I like the displayed text to be larger”, “I like the volume set at [level]”, “Turn on audio descriptive setting”, etc.).

As described herein, in some embodiments, the language model orchestrator 530 may cause the user knowledge determination component 115 to process data (e.g., user input(s)/dialog data) to determine user knowledge data for storage at the user knowledge data storage 130. In other embodiments, the language model 545 may itself infer / generate user knowledge data based on processing the user input(s)/dialog data and may cause storage of the user knowledge data at the user knowledge data storage 130.

FIG. 5 illustrates further example components included in the system 100 configured to use a language-model based approach to determine an action to be performed in response to a user input and determine a response to be presented to a user 505. As shown in FIG. 5, the system 100 may include a user device 510, local to the user 505, in communication with one or more system component(s) 520 via a network(s) 199. The network(s) 199 may include the Internet and/or any other wide-or local-area network, and may include wired, wireless, and/or cellular network hardware.

In some embodiments, the system component(s) 520 may include various components that may support processing by a language model, such as a language model orchestrator component 530. In example embodiments, the language model orchestrator component 530 may include an initial plan generation component 535, a prompt generation component 540, at least one language model 545, and an action plan generation component 550. The system component(s) 520 may further include an action plan execution component 525 configured to facilitate/cause performance of actions that may be determined by the language model 545. The system component(s) 520 may further include one or more responding components 560 that may perform the actions.

The responding components 560 may be configured to perform an action related to a user input, including, but not limited to retrieving information potentially relevant for determining a response to the user input (e.g., data from a knowledge base, Internet search, database, an application, etc.; context related to the interaction; relevant exemplars for a prompt to the language model; relevant application programming interfaces (APIs); etc.), operating a user device (e.g., a smart home device such as a TV, lights, a kitchen appliance, etc.), determining a synthesized speech output, or other actions described herein. As shown in FIG. 5, the responding components 560 may include an API retriever component 542 (further described below), a synthesized speech generation (SSG) component 556, one or more skill/app components 554 and other components described herein.

APIs are a way for one program/component to interact with another. API calls are a mechanism by which the program/component interact. An API call, or API command, is a message sent to a system component asking an API to perform an action, provide a service or information, or the like. An API call may be formatted for the particular API and may include a particular command, optionally using particular arguments and argument values. API calls may be used for a variety of purposes, such as controlling other devices (e.g., an API call of turn_on_device (device=“indoor light 1”) corresponds to a command for a component to turn on a device associated with the identifier “indoor light 1”), obtaining information from other components (e.g., an API call of InfoQA. question (“Who is the president of USA?”) corresponds to a command for a component to find and provide an answer to the indicated question), and performing other actions (e.g., generating synthesized speech, searching data sources, etc.). The system 100 may interact with the responding components 550 via API calls.

The language model orchestrator component 530 may be configured to orchestrate processing by the language model 545. In some embodiments, the language model 545 may be configured to perform one or more stages of processing, which may be referred to as a task generation stage, an action (or directive) generation stage, and a response generation stage.

The processing stages may be performed in a particular order. For example, during a first stage of processing, the language model 545 may be tasked with performing task generation to generate a list of tasks to be performed in order to respond to a user input. During a second stage of processing, based on the list of tasks, the language model 545 may be tasked with performing action generation to generate action requests (or directives) for a responding component(s) 560 to perform an action(s) related to the tasks/user input. During a third stage of processing, based on information received from the responding component(s) 560, the language model 545 may be tasked with generating a response to the user input and/or causing a component(s) of the system 100 to perform further action(s). Further details are described herein in relation to FIG. 6.

In some cases, a subset of the stages may be performed. For some user inputs, the language model 545 may only perform the task generation stage and the response generation stage, where a response to a user input is generated by the language model 545 using parametric knowledge. For example, for a user input “What kind of fruit is lemon?”, the language model 545 may determine that the task is to answer the user's question and may generate a response “Lemon is a citrus fruit that grows on tress” based on the model's parameter knowledge learned during configuration/training operations. In such examples, the language model 545 may not determine an action that is to be performed using a system component, such as sending a request for information to a knowledge base (e.g., the language model 545 may respond without using external knowledge).

In some embodiments, the system may use Retrieval-Augmented Generation (RAG) techniques to inform processing of a language model. RAG techniques may involve referencing an authoritative knowledge base or other type of data source outside of the model's training data sources before generating a response by the model. RAG techniques may extend the already powerful capabilities of language models to specific domains, an organization's internal knowledge base, etc., without the need to retrain the model. In some embodiments, information (e.g., relevant facts, up-to-date information, current/trending topics, etc.) from one or more components (e.g., responding component(s) 560) may be provided to the language model 545 and the model may generate a output based on the received information.

In some embodiments, the language model orchestrator component 530 may be configured to orchestrate processing by multiple different language models, where an individual language model may perform one (or more) of the processing stages described above. For example, a first language model may perform task generation, a second language model may perform action generation, and a third language model may perform response generation. In some embodiments, the language models may be different types of models, for example, a first language model may be a text-to-text generative model, a second language model may be a multi-modal generative model, a third language model may be a text-to-speech generative model, etc. In some embodiments, the language models may be different sizes (e.g., number of parameters), may have different processing capabilities, etc.

Some embodiments may enable use of other components, such as plugins, with the language model 545, where the plugins may add functionality and features to the language model capabilities. For example, the plugins may be used to perform mathematical calculations (e.g., a calculator plugin), statistical analysis (e.g., a statistics plugin), natural language translation, speech generation, etc. For further example, the plugins may additionally, or alternatively, be used to perform an action responsive to a user input based on the response generated by the language model. As a further example, the plugins may cause the language model to process and output according to an enabled plugin, which may result in a different response, reasoning, processing, etc. from the language model than when the plugin is not enabled. In some cases, a user or a system may enable a plugin(s) for use with the language model.

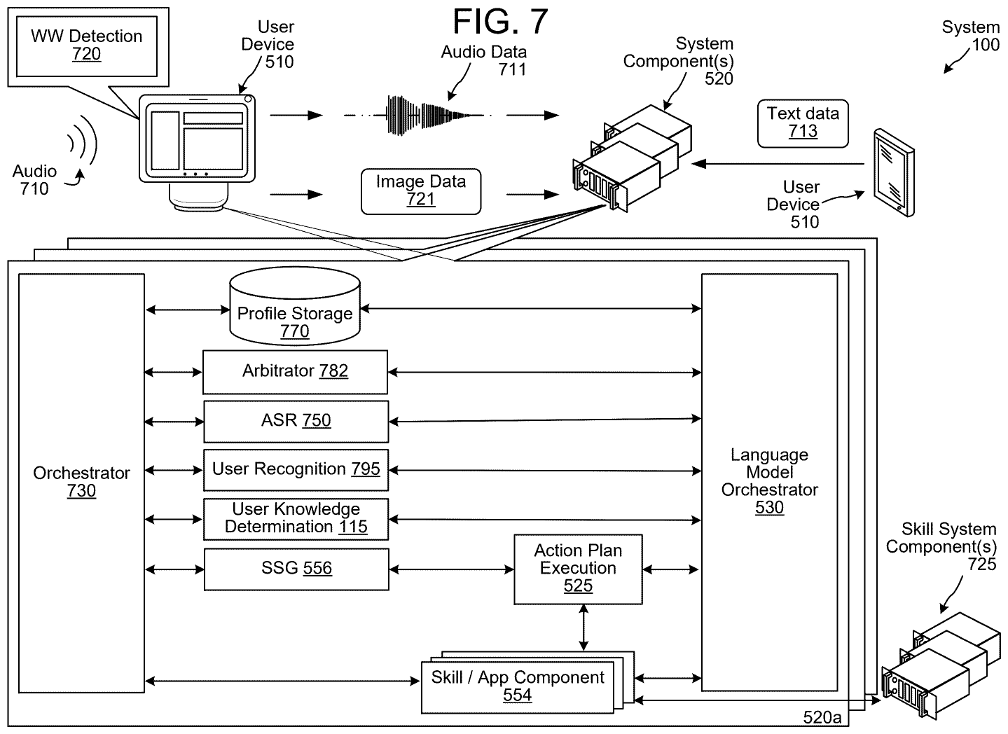

The system component(s) 520 may include other processing components configured to process user inputs and other type of inputs (e.g., sensor data, audio data, data indicative of an event occurring, etc.) received via the user device 510. In example embodiments, the system component(s) 520 may process spoken inputs using ASR processing. The system component(s) 520 may also be configured to process non-spoken inputs, such as gestures, textual inputs, selection of GUI elements, selection of device buttons, etc. The system component(s) 520 may also include other components to understand an input, determine an action to be performed in response to receiving the input, generate an output responsive to the input, and the like. Such other components may perform natural language processing, SSG processing, etc., some of which are described herein in relation to FIG. 7.

As shown in FIG. 5, the system component(s) 520 may receive user input data 527, which may be provided to the language model orchestrator component 530 (as shown in FIG. 6). In some instances, the user input data 527 may include one or more types of data, such as text (e.g., a text or tokenized representation of a user input), audio, image, video, etc. Such data may be encoded / embedded data that represent the underlying type of data (e.g., text, audio, image, etc.). For example, the user input data 527 may include text (or tokenized) data when the user input is a natural language user input. In some embodiments, an ASR component 750 of the system 100 may receive audio data representing a spoken natural language user input from the user 505. The ASR component 750 may perform ASR processing on the audio data to determine ASR data representing the spoken user input, which may correspond to a transcript of the user input. As described herein, with respect to FIG. 7, the ASR component 750 may determine ASR data that includes an ASR N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the ASR component's 750 level of confidence that the corresponding hypothesis represents what the user said. The ASR component 750 may also determine token scores corresponding to each token/word of the ASR hypothesis, where the token score indicates the ASR component's 750 level of confidence that the respective token/word was spoken by the user. The token scores may be identified as an entity score when the corresponding token relates to an entity. In some instances, the user input data 527 may include a top scoring ASR hypothesis of the ASR data. As an even further example, in some embodiments, the user input may correspond to an actuation of a physical button, data representing selection of a button displayed on a graphical user interface (GUI), image data of a gesture user input, combination of different types of user inputs (e.g., gesture and button actuation), etc. In such embodiments, the system 100 may include one or more components configured to process such user inputs to generate the text or tokenized representation of the user input (e.g., the user input data 527). As a further example, the user input data 527 may include image data representing information being displayed at the user device 510 (e.g., on-screen context data) when the user 505 provides the user input or at substantially the same time as the user 505 provides the user input. As yet a further example, the user input data 527 may include audio data representing audio signals (e.g., background noise, audio from other devices such as TV, appliances, etc.) occurring in the environment of the user 505 that can be captured by the user device 510 (e.g., audio environment context). As yet a further example, the user input data 527 may include image data representing one or more objects in the environment of the user 505 (e.g., visual environment context). As yet a further example, the system may receive image data including text (and other data), and the user input data 527 may include text determined from the image data using optical character recognition or other techniques.

In some embodiments, the system component(s) 520 may receive input data that may not be provided directly/explicitly by a user. Such other type of input data may be processed in a similar manner as the user input data 527 as described herein. Such other type of input data may be received in response to detection of an event. Example events include change in a device state (e.g., front door opening, garage door closing, TV turned off, thermostat detecting a particular temperature, etc.), occurrence of an acoustic event (e.g., baby crying, appliance beeping, glass breaking, etc.), presence of a user (e.g., a user approaching the user device 510, a user entering the home, etc.), occurrence of an event indicated by a user (e.g., a reminder/notification requested by the user, sporting event score change, start of a TV program, calendar event, etc.), and others. In some embodiments, the system 100 may process the input data and generate a response/output. For example, the input data may be received in response to detection of a user generally or a particular user, an expiration of a timer, a time of day, detection of a change in the weather, a device state change, etc. In some embodiments, the input data may include data corresponding to the event, such as sensor data (e.g., image data, audio data, proximity sensor data, short-range wireless signal data, etc.), a description associated with the timer, the time of day, a description of the change in weather, an indication of the device state that changed, etc. The system 100 may include one or more components configured to process the input data to generate a natural language representation of the input data. The system 100, for example, the language model orchestrator component 530 may process the input data and may cause performance of an action. For example, in response to detecting a garage door opening, the system 100 may cause garage lights to turn on, living room lights to turn on, etc. As another example, in response to detecting an oven beeping, the system 100 may cause a user device 510 (e.g., a smartphone, a smart speaker, etc.) to present an alert to the user. The language model orchestrator component 530 may process the input data to generate tasks (e.g., an action plan) that may cause the foregoing example actions to be performed.

FIG. 6 illustrates example processing of the user input data 527 by the system component(s) 520 using the language model 545. Although the figure and discussion of the present disclosure illustrate certain components and steps in a particular order, the components may be implemented in a different manner (as well as certain components removed or added) and the steps described may be performed in a different order (as well as certain steps removed or added) without departing from the present disclosure.

In some embodiments, the language model 545 may perform iterative processing (e.g., multiple processing cycles, multiple processing stages, etc.) with respect to individual user input data 527. Such iterative processing is illustrated and described herein with respect to FIG. 6.

For example, in a first iteration of processing the language model 545 may receive a first prompt from the prompt generation component 540, in response to which the language model 545 may determine one or more tasks to be performed with respect to the user input data 527, then at least one of the determined task(s) may be performed via the action plan execution component 525, the results of the performed task(s) may be provided to the language model 545 via a second prompt, in response to which the language model 545 may determine further tasks to be performed or may determine that a (final) response to the user input is determined.

The initial plan generation component 535 may be configured to determine various information relevant to processing of the user input data 527 by the language model orchestrator component 530. The initial plan generation component 535 may generate an action plan (e.g., action plan for prompt data 626) representing one or more tasks/actions to be performed to determine the various relevant information. The relevant information may be included in a prompt to the language model 545. The initial plan generation component 535 may receive (step 1) the user input data 527 representing a user input from the user 505. Based on the user input data 527, the initial plan generation component 535 may determine information relevant for processing the user input data 527 and may output (step 2) the action plan for prompt data 626. The action plan for prompt data 626 may include one or more tasks to be performed to retrieve the relevant information. The tasks may be represented as action descriptions, API requests/calls, API descriptions, requests to a component(s) (e.g., the responding components 560), and the like. Examples tasks that may be included in the action plan for prompt data 626 may relate to obtaining certain information like context data, user profile data, user preferences, available/relevant exemplars, available/relevant APIs, etc.

In example embodiments, the initial plan generation component 535 may determine one or more types of context data relevant for the user input data 527. Types of context data may include user context (e.g., user location, user profile identifier, user demographics, user profile data, user preferences, personalized catalogs, enabled skills/applications, etc.), device context (e.g., device type, device identifier, device location (e.g., living room, kitchen, office, etc.), device capabilities, device state, etc.), environmental context (e.g., time/date the past user input was received/processed, device that received the user input, device that responded to the user input, objects proximate to the device/user, background audio/noises, state/status of device(s) in the user's environment (e.g., TV is on, thermostat temperature, etc.), dialog context (e.g., prior user inputs of a dialog, prior system responses of the dialog, dialog topic, actions performed during the dialog, etc.), and the like. As an example, if the user input data 527 corresponds to operation of a device (e.g., the user input corresponds to a smart home domain), the initial plan generation component 535 may determine that device context information, in particular device states for the devices associated with the user/user profile of the user 505, may be relevant information. As another example, if the user input data 527 corresponds to output of media, such as music, movies, TV shows, etc., the initial plan generation component 535 may determine that user context information, in particular user preference for media genre associated with the user/user profile of the user 505, may be relevant information.

Based on the type of context data determined to be relevant, the initial plan generation component 535 may output the action plan for prompt data 626 to include a request for the type(s) of context data. For example, if device context is relevant information, then the action plan for prompt data 626 may include an API call/description corresponding to a component (e.g., a device state component, a smart home component, a user profile storage, etc.) capable of providing device information. As another example, if user context is relevant information, then the action plan for prompt data 626 may include an API call/description corresponding to a component (e.g., a user profile storage, a personalized context component, etc.) capable of providing user information.

In some embodiments, the initial plan generation component 535 may determine one or more components or types of components that may be relevant for processing the user input data 527. As an example, if the user input data 527 corresponds to operation of a device (e.g., the user input corresponds to a smart home domain), the initial plan generation component 535 may determine that components (e.g., APIs) corresponding to device operation or smart home domain may be relevant, and the initial plan generation component 535 may output the action plan for prompt data 626 to include device operation components or smart home domain components. As another example, if the user input data 527 corresponds to output of media, the initial plan generation component 535 may determine components corresponding to media output or music domain may be relevant, and the initial plan generation component 535 may output the action plan for prompt data 626 to include media output components or music domain components.

In some embodiments, the initial plan generation component 535 may determine a query to retrieve exemplars and/or APIs relevant for processing the user input data 527 using the language model 545. As used herein, an exemplar refers to information that may be included in a prompt to a language model that provides an example of how the language model is to process or respond, including, among other things, what actions the language model can request performance of. A prompt may include more than one exemplar. Few shot learning or in-context learning by the language model is enabled by including the exemplars in the prompt. The query (or request) to retrieve relevant exemplars and/or APIs may be included in the action plan for prompt data 626. The query (or an API request based on the query) may be processed by the responding component 560 (e.g., an exemplar retriever component, the API retriever component 542, etc.). The query, in some embodiments, may include the user input data 527 or a portion or representation thereof.

The initial plan generation component 535 may employ one or more techniques to determine relevant information or to determine the tasks to obtain relevant information. Examples of such techniques include using one or more of machine learning models (e.g., classifiers), statistical models, rules engines, etc. to determine the relevant information. The initial plan generation component 535 may determine a topic/category corresponding to the user input data 527, a (semantically or lexically) similar past user input and relevant information corresponding to the similar past user input, and the like.

In example embodiments, the initial plan generation component 535 may use a language model to determine the types of information relevant for processing the user input data 527. The initial plan generation component 535 may input a prompt to the language model, for example, “What types of information is relevant for responding to the user input: [user input data 527]”, and the language model may output one or more types of context data, one or more types of components, etc. that may be relevant. In some embodiments, the initial plan generation component 535 may input a prompt to the language model 545 requesting relevant information for the user input data 527.

The action plan for prompt data 626, which includes types of relevant information for the user input data 527 or tasks to be performed to obtain the relevant information, may be processed by the action plan execution component 525 to retrieve the relevant information. The action plan execution component 525 may process the action plan for prompt data 626 to generate one or more requests to perform an action (e.g., API requests 636) for a particular responding component 560. For example, if the action plan for prompt data 626 indicates that device information/context is relevant, then the action plan execution component 525 may generate an API request 636 for a responding component 560a capable of providing the device information, where the API request 636 may include a user profile identifier associated with the user 505, a device identifier associated with the user device 510, and/or other information based on information required in the API call for the responding component 560a.

The API request 636 may be sent (step 3) to the corresponding responding component(s) 560. The responding component(s) 560 may include components that the action plan execution component 525 may communicate with via API requests or other type requests.

As shown in FIG. 5, the responding component(s) 560 may include one or more skill/app components 554, the SSG component 556 (e.g., configured to convert input data to audio data representing synthesized speech), and the API retriever 542 (e.g., configured to provide APIs and corresponding information supported by the system 100). The responding component(s) 560 may also include an orchestrator component 730 (e.g., configured to facilitate processing by other system components 520 such as those shown in FIG. 7), a context source component (e.g., configured to provide user context data, device context data, environmental context data, dialog context data, personalized context data, etc.), a multimodal response component (e.g., configured to respond to a user input via outputs in more than one data form), a content moderation component (e.g., configured to moderate certain types of content such as biased content, harmful content, offensive content, etc.), a smart home devices component (e.g., configured to provide device information such as device state, device capabilities, etc.), a language model-based agent (e.g., a component that uses a language model (e.g., a LLM) or other type of generative model to provide information), an exemplar provider component (e.g., configured to respond to a query for relevant exemplars), a knowledge base component (e.g., including one or more knowledge bases or other structured data that can be searched to obtain information), an entity resolution component (e.g., configured to determine specific entities corresponding to entities represented in a user input or language model output), and the like.

In response to receiving the API request 636 (at step 3), the responding component(s) 560 may provide (step 4) an API response(s) 662 to the action plan execution component 525. At step 3, the API request(s) 636 is based on the action plan for prompt data 626, and thus, at step 4, the API response(s) 662 may include information relevant for processing the user input data 527. In examples, the API response(s) 662 may include relevant context information (e.g., device context, user context, environment context, dialog context, personalized context, etc.), relevant APIs and/or API descriptions for processing the user input data (e.g., API(s) for operating devices, API(s) for outputting media content, etc.), relevant exemplars, and other relevant information requested via the action plan for prompt data 626.

In example embodiments, the API request 636 may be sent to the API retriever component 542. In such cases, the API request 636 may include a query to retrieve relevant APIs based on the user input data 527. The API retriever component 542 may be configured to receive a search query and output one or more APIs or API data corresponding to (e.g., satisfying, matching, etc.) the search query. API data may include an API call, an API description, and other information associated with the API. In some embodiments, the API retriever component 542 may include or may be in communication with an index storage 544 (shown in FIG. 5). The index storage 544 may store various information associated with multiple APIs. Examples of information stored in the index storage 544 include: API/component descriptions (e.g., a description of one or more function that the API can be used to perform), API arguments (e.g., parameter inputs, input types, examples of input values, examples of output values, output type, etc.), identifiers for components corresponding to the API (e.g., alphanumerical component ID, component name, etc.), and other information. In some embodiments, the index storage 544 may include other information associated with the API, such as historical accuracy/defect rate, historical latency value, feedback (e.g., user satisfaction/feedback, system-based feedback), etc. The index storage 544 may also include sample user inputs corresponding to the API, where the sample user input may represent a user input for which the API can perform an action for.

The API retriever component 542 may apply one or more retrieval techniques to determine API data corresponding to the search query. For example, the API retriever component 542 may compare one or more APIs included/represented in the index storage 544 to the user input data 527 represented in the search query to determine one or more APIs (top-k list). Such comparison may involve a semantic comparison between the user input data 527 and the API data. In some embodiments, the API retriever component 542 may use a neural-based retrieval technique that may involve determining an encoded representation of the user input/search query and comparing (e.g., using cosine distance) the encoded representation(s) of the API data in the index storage 544. The relevant APIs may be included in the API response 662.

In a non-limiting example, for a user input “book a flight”, the API retriever component 542 may determine one or more API calls corresponding to booking a flight (e.g., Bookflight. location (“departing airport code”, “arrival airport code”), Bookflight. date (“departing date”), bookflight. rountrip (“departing location”, “arrival location”, “departure date”, “return date”), AirlineBookFlight (“departing airport code”, “arrival airport code”), etc.).

Some embodiments may include an exemplar provider component that may operate in a similar manner as the API retriever component 542 in terms of implementing one or more retrieval techniques to determine exemplars corresponding to (e.g., satisfying, matching, etc.) a search query based on the user input data 527. The exemplar provider component may search an index storage including various information related to multiple different exemplars. In some embodiments, the index storage may include sample user inputs associated with an exemplar, and the relevant exemplars may be retrieved based on a comparison of the sample user inputs and the user input data 527. The retrieved exemplars may be included in the API response 662.

The information from the API response(s) 662 may be included in a prompt to the language model 545. The action plan execution component 525 may determine action plan response data 638 based on the API response(s) 662. The action plan execution component 525 may combine (e.g., aggregate, summarize, de-duplicate, etc.) multiple API responses 662 to generate the action plan response data 638. In some examples, the action plan response data 638 may be the same or similar to the API response(s) 662. The action plan execution component 525 may send (step 5) the action plan response data 638 to the prompt generation component 540.

Using the action plan response data 638, the prompt generation component 540 may determine prompt 642 for the language model 545. The prompt 642 may be a natural language input (e.g., a natural language request, a natural language instruction, etc.). In some embodiments, the prompt 642 may include information in a manner that the language model 545 is trained for. The prompt generation component 540 may send (step 6) the prompt 642 to the language model 545, where the prompt 642 may include the user input data 527 (or a representation of the user input data 527) and the relevant information for processing the user input data 527. For example, the prompt 642 (at step 6) may include relevant context data, relevant APIs or API descriptions, etc. that may be included in the action plan response data 638. In some embodiments, the prompt 642 may include a request or directive for the language model 545 to respond to the user input data 527. In some embodiments, the prompt 642 may include one or more exemplars (e.g., in-context learning examples) for processing the user input data 527.

The prompt 642 may include indicators (e.g., labels, specific tokens, etc.) to identify certain information. In example embodiments, the prompt 642 may include a “User” indicator (to indicate that the following string of characters/tokens are the user input), an “Exemplar” indicator (to indicate exemplars), and so on.

In some embodiments, the prompts for the language model described herein may include a request for the language model to output a response that satisfies certain conditions.

Such conditions may relate to generating a response that is unbiased (toward protected classes, such as gender, race, age, etc.), non-harmful, profanity-free, etc. For example, prompt data generated by a prompt generation component described herein may include “Please generate a polite, respectful, and safe response and one that does not violate protected class policy.”

In some embodiments, the prompt 642 may include an indication the processing stages (e.g., the task generation stage, the action generation stage, and the response generation stage) that the language model 545 is to perform. In some examples, for the task generation stage, the prompt 642 may direct the language model 545 to generate an output (e.g., tokens) representing the model's interpretation of the user input and/or one or more tasks to be performed to respond to the user input (the model output may be, for example, the user is requesting [intent of the user input], the user wants to [desired user action], need to determine [information needed to properly process the user input], etc.). For the task generation stage, the prompt 642 may also direct the language model 545 to prioritize a list of tasks to be performed, if more than one task is to be performed and select one (or more) task for the current iteration of processing.

In some examples, for the action generation stage, the prompt 642 may direct the language model 545 to generate an output (e.g. tokens) representing an action(s) (or directive(s)) and/or an API call(s) corresponding to the user input, where performance of the action(s) or execution of the API(s) can be done to retrieve information to determine a response to the user's input, perform the user requested action, retrieve information/data to perform other tasks on the task list, etc. In some examples, for the action generation stage, the prompt 642 may direct the language model 545 to process the results of the action(s)/API(s) determined by the language model 545, and to determine whether a response to the user input can be generated or whether there are further tasks to be performed from the task list.

In some examples, for the response generation stage, the prompt 642 may direct the language model 545 to generate an output (e.g., tokens) representing a response (e.g., a final response) to the user input data 527. In examples, the language model 545 may be directed to generate the response based on the results of performing the action(s)/API(s).

The prompt generation component 540 may send (step 6) the prompt 642 to the language model 545, which may process the prompt 642 to generate a language model (LM) response 646. The LM response 646 may be a natural language output generated based on the prompt 642. The LM response 646 may include text tokens. In other embodiments, where the language model 545 may be a multi-modal model, the LM response 646 may include other types of tokens, for example, audio tokens, image tokens, etc.

Based on receiving the prompt 642 at step 6, the language model 545 may generate the LM response 646 at step 7, where the instant LM response 646 may include outputs corresponding to the task generation stage and the action generation stage. The LM response 646 may include an action for determining information relevant to or responsive to the user input data 527. For example, the LM response 646 may include an action to search a knowledge base (e.g., to find a response to a user question), an action to determine information from a particular skill/app or language model-based agent (e.g., to determine current weather information, to determine a cost of an item, to book travel, etc.), an action to operate a device (e.g., turn on lights, set thermostat to a particular temperature, etc.), an action to request information from the user 505, etc.

In some embodiments, the LM response 646 may include an API or API description corresponding to the determined action. For example, the LM response 646 may include an API to operate a device or an API call(s) to output media content. The language model 545 may determine the actions and/or the API information based on the relevant APIs included in the prompt 642. The language model 545 may generate actions and/or API information that is not based on (e.g., correspond to, is similar to, etc.) the relevant APIs included in the prompt 642 (for example, the language model 545 may generate incorrect/unsupported actions and/or API information).

The LM response 646 may follow the format included in the prompt 642 or that the language model 545 is trained to follow. An example prompt 642 may be:

{

Please process the following user input and context data to determine at least one action or API to execute and generate a response to the user.

First determine a task to perform (use “Task” label), then determine an API to perform the task (use “Action” label), then process the results from the API, and then generate a response to the user input (use “Response” label). You may determine multiple tasks to perform. You may have to process iteratively.

User: Turn on living room TV

Available context:
User devices: “living room TV”=[device id]
“living room TV” device state=Off

Available APIs:
TurnOn. device (device)
TurnVolumeUp. device (device)
SetTVChannel (device, input channel)

}

Based on processing the above example prompt 642, an example LM response 646 (at step 7) may be:

{

Task: User wants to turn on living room TV that is operation of a user device.

Action: I need an API to operate a device. TurnOn. device (device=“living room TV”)

}

The LM response 646 may be sent (step 7) to the action plan generation component 550, which may determine action plan data 652. As described herein, the language model 545 may generate tokens in sequence, as such, the language model 545 may generate portions of the LM response 646 in a tokens-by-tokens basis. In some embodiments, the LM response 646 may be processed by the action plan generation component 550 based on the language model 545 generating the tokens representing the action or corresponding to the action generation stage.

The action plan generation component 550 may process the LM response 646 to identify one or more actions/APIs generated by the language model 545. In examples, the action plan generation component 550 may parse the tokens/text included in the LM response 646 to extract tokens/text representing an action or API. In some embodiments, the action plan generation component 550 may be configured to determine one or more components (e.g., responding components 560a-n) configured to perform the identified action or API. Based on the LM response 646, the action plan generation component 550 may determine the action plan data 652, which may in turn cause performance of an action (e.g., execution of API calls) to determine a potential responses(s) to the user input. The action plan data 652 may include one or more APIs to be executed, where the APIs may be determined based on (e.g., extracted from) the LM response 646. For example, if the LM response 646 includes an action of “determine weather forecast for today” or an API call of “GetWeather.location ([city])”, then the action plan generation component 550 may determine the action plan data 652 to include an API call “GetWeather.location ([city])” and include an identifier for the responding component(s) 560a (e.g., a weather skill component). Instead of or in addition to an API call, the action plan data 652 may include a request to perform an action, an API description, etc. In some embodiments, the action plan generation component 550 may determine the responding components 560 based on user permissions, subscriptions, authorization or other use-enabling information associated with the user 505 (e.g., included in user profile data).

In some embodiments, the action plan generation component 550 may be configured to determine more than one responding component 560 to perform the action/execute the API indicated in the LM response 646. In some embodiments, the action plan generation component 550 may determine APIs corresponding to multiple responding components 560. For example, for the “GetWeather.location ([city])” API, the action plan data 652 may include an identifier for a first weather skill component, an identifier for a second weather skill component, an identifier for a search engine component, etc.

The action plan data 652 may be sent (step 8) to the action plan execution component 525. The action plan execution component 525 may identify the APIs in the action plan data 652 and generate executable API calls for the corresponding responding components 560. Based on the action plan data (received at step 8), the action plan execution component 525 may generate an additional (a second) API request (or multiple API requests) 636. The (additional/second) API request(s) 636 may be sent (step 9) to the responding component(s) 560. For example, the action plan execution component 525 may send a first API call to a first responding component 560a and a second API call to a second responding component 560b.

In some cases, the action plan data 652 may include incomplete API calls and the action plan execution component 525 may be configured to generate executable API calls (e.g., complete API calls) corresponding to the action plan data 652.

The action plan execution component 525 may generate one or more executable API calls including one or more parameters using information included in the action plan data 652 and/or various other contextual information (e.g., speaker recognition results, a user ID, user profile information (e.g., age, gender, location, language, geographic marketplace, etc.), device ID, device profile information, device state indicators, a dialog history, and/or a interaction history associated with the user and/or the device, etc.). In some embodiments, the various contextual information may be contextual information not provided to the language model orchestrator component 530. Prior to generating the executable commands, the action plan execution component 525 may modify (e.g., remove, filter, preempt, etc.) a directive included in the action plan data 652 that is determined to be in conflict with a system operating policy. The action plan execution component 525 may generate one or more additional executable commands corresponding to directives not included in the action plan data 652.

In response to receiving the API request(s) 636 (at step 9), the responding component(s) 560 may send (step 10) an (additional/second) API response(s) 662 to the action plan execution component 525. The action plan execution component 525 may determine (additional/second) action plan response data 638 based on the (additional/second) API response(s) 662. The action plan execution component 525 may combine (e.g., aggregate, summarize, de-duplicate, etc.) multiple API responses 662 to generate the action plan response data 638. In some examples, the action plan response data 638 may be the same or similar to the API response(s) 662. In some examples, the action plan response data 638 may include an identifier associated with the responding component 560 that provided the API response 662.

For example, the (additional/second) action plan response data 638 may include first weather information from a first weather skill component, second weather information from a second weather skill component, third weather information from a search engine component, etc. In some embodiments, the action plan execution component 525 may remove/filter information from the API response 662 that is determined to include information not beneficial to the processing by the language model 545.

The action plan execution component 525 may send (step 11) the (additional/second) action plan response data 638 to the prompt generation component 540. The information from the API response(s) 662 may be included, by the prompt generation component 540, in a (additional/second) prompt to the language model 545. The prompt generation component 540 may generate the second prompt 642 to include the action plan response data 638 or a representation thereof. The second prompt 642 may also include information from the prior/first prompt (from step 6). For example, the second prompt 642 may include the user input data 527 (or a representation thereof), the relevant information for processing the user input data 527 (e.g., relevant context data, relevant API information, relevant exemplars, etc.), the processing stages information, and the action plan response data 638 (from step 11). In some embodiments, the second prompt 642 may also include at least a portion of the LM response 646 generated during a prior iteration of processing (e.g., the outputs based on performing the task generation stage and the action generation stage) to indicate actions/results of the prior iteration of processing by the language model 545. The second prompt 642 may include an indicator (e.g., label, identifier, etc.) associated with the action plan response data 638 to indicate, to the language model 545, that the string of characters/tokens following the indicator represent information determined based on performance of the actions determined during the action generation stage.

The second prompt 642 may be sent (step 12) to the language model 545 for processing. At this point, the language model 545 may perform the action generation stage of processing the results of the performed actions, which may involve interpreting or understanding the results included in the action plan response data 638. The language model 545 may generate (step 13) a (additional/second) LM response 646 based on the second prompt 642. The second prompt 642 may include a request or directive to the language model 545 to perform further processing with respect to the user input data 527. As described above, the second prompt 642 may provide, among other things, responses/results of performance of the action determined by the language model 545 determined during the prior iteration of processing. The language model 545 may generate further actions to be performed to respond to the user input data 527 (as part of the action generation stage) or may generate a (final/user-facing) response to the user input data 527 (as part of the response generation stage).

An example second prompt 642 may be:

{

Please process the following user input and context data to determine at least one action or API to execute and generate a response to the user.

First determine a task to perform (use “Task” label), then determine an API to perform the task (use “Action” label), then process the results from the API, and then generate a response to the user input (use “Response” label). You may determine multiple tasks to perform. You may have to process iteratively.

User: Turn on living room TV

Available context:
User devices: “living room TV”=[device id]
“living room TV” device state=Off

Available APIs:
TurnOn. device (device)
TurnVolumeUp. device (device)
SetTVChannel (device, input channel)

Prior Iteration:
Action: TurnOn. device (device=“living room TV”)

TurnOn.device (device=“living room TV”); API response: “living room TV” device state=ON

}

Based on the above example prompt 642, an example LM response 646 may be:

{

Task: User wants to turn on living room TV that is operation of a user device.

Action: I need an API to operate a device. TurnOn. device (device=“living room TV”)

Action result is “living room TV” device state=ON

Response: The living room TV is on now. Can I help you with anything else?

}

As described herein, the language model 545 may generate the LM response 646 on tokens-by-tokens basis. As such, in some examples, the second LM response 646 may include additional tokens (e.g., newly generated tokens) to the first LM response 646 (from step 7). In other examples, the second LM response 646 may include different tokens than the first LM response 646, where the currently generated tokens may represent outputs for further steps of the action generation stage and/or the response generation stage.

The language model 545 may determine further actions/APIs to be performed in a similar manner as described above. Such further actions/APIs may be based on any tasks, included in the task list generated during the task generation stage, that are still to be performed (e.g., a first task of booking a flight may be done, now a second task of booking a hotel is to be performed). Additionally or alternatively, the further actions/APIs may be based on the results included in the action plan response data 638 (at step 11) (e.g., an API response from a responding component 560 may indicate that additional information is needed to perform an action).

The language model 545 may determine a (final) response to the user input, where the response is to be presented to the user 505 via the user device 510. In other cases, the response may be presented via another user device 510 associated with the user 505. The language model 545 may determine the final response based on the results included in the action plan response data 638 (from step 11). For example, the language model 545 may summarize the results, may combine the results, may generate an interpretation of the results, etc. In a non-limiting example, the language model 545 may combine weather information from two or more responding components (e.g., combine high/low temperature information from a first responding component with humidity information from a second responding component). In another non-limiting example, the language model 545 may interpret results from a knowledge base component to determine a response to the specific user query (e.g., from a biographical search result for a historical person, a birthplace and siblings information may be extracted to determine a response to a user query “tell me about [person's] childhood”).

In some examples, the language model 545 may generate the further action to be performed is requesting additional information from the user 505. Such further action, in some embodiments, may be labeled as “Response” so that the action plan generation component 550 may cause a request to be output to the user 505.

The second LM response 646 may be sent (step 13) to the action plan generation component 550, which may determine (step 14) the (additional/second) action plan data 652. In some examples, the second LM response 646 sent to the action plan generation component 550 may include further action(s)/API(s) to be executed, which may be labeled with “Action. ” In some examples, the second LM response 646 may include a final response to the user input, which may be labeled with “Response.”

Based on the tokens corresponding to the “Action” label, the action plan generation component 550 may determine the action plan data 652 to include one or more actions, one or more API calls and/or one or more responding components 560 corresponding to the action(s)/API(s) determined by the language model 545.

Based on the tokens corresponding to the “Response” label, the action plan generation component 550 may determine the action plan data 652 to include one or more actions, one or more API calls and/or one or more responding components 560 to present the output tokens to the user 505 as a response to the user input. For example, the action plan data 652 may include an identifier for the SSG component 556 to cause the output tokens, generated by the language model 545, to be presented as synthesized speech. As another example, the action plan data 652 may include an identifier for the responding component 560 capable of generating outputs in more than one form (e.g., a multi-modal output component) to cause the tokens to be presented as synthesized speech, displayed text/graphics, and/or other types of outputs.

The (second) action plan data 652 may be sent (step 14) to the action plan execution component 525, and as described herein, the action plan execution component 525 may determine executable API calls based on the action plan data 652. If the action plan data 652 represents additional actions to be performed, then the action plan execution component 525 may cause the corresponding responding component(s) 560 to perform the additional action(s) and corresponding response(s) (e.g., API responses 662) may be communicated to the prompt generation component 540 (via the action plan execution component 525 and action plan response data 638) to initiate another iteration of processing by the language model 545 with respect to the user input data 527. If the action plan data 652 represents a response to be presented to the user 505, then the action plan execution component 525 may cause the corresponding responding component(s) 560 to determine output data (e.g., responsive output data 562 shown in FIG. 5) that may be presented via the user device 510. For example, the responsive output data 562 may be sent to the user device 510 via the orchestrator component 730 or another system component(s) 520 (described in relation to FIG. 7).

In some embodiments, when further actions are generated by the language model 545 to be performed with respect to the user input data 527, the language model orchestrator 530 may perform another iteration of processing, which may involve generating another prompt 642 to the language model 545, generating another LM response 646 that may be used to determine further action plan data 652. The language model 545 may generate tokens corresponding to the action generation stage and/or the response generation stage during the further iteration.

In some embodiments, when a final response is generated by the language model 545, further processing with respect to the user input data 527 by the language model orchestrator 530 may be ceased (e.g., processing with respect to the user input data 527 by the language model orchestrator 530 may be complete). The language model orchestrator 530 may process with respect to a subsequently received user input, which may or may not be part of the same dialog session as the prior/already processed user input data 527.

The responsive output data 562 may include one or more of output audio data representing synthesized speech, text data for display, image for display, graphics/icons for display, media (e.g., video, music, background music, notification sounds, etc.) for playback, and other data. In some embodiments, the responsive output data 562 may include placement information representing where (e.g., top banner, left portion, center of screen, overlay on current visual, etc.) on the display screen of the user device 510 the output data is to be displayed. In some embodiments, the responsive output data 562 may be determined/provided by the responding component 560. In some embodiments, another system component 520 may process the responsive output data 562 prior to sending to the user device 510 to ensure that the responsive output data is formatted for the particular user device 510.

Referring again to FIG. 5, as shown, the system component(s) 520 may include a compliance component 570. In some embodiments, the compliance component 570 may be included in the language model orchestrator component 530. In other embodiments, the compliance component 570 may be one of the responding components 560 and the action plan generation component 550 may cause the action plan execution component 525 to send an API request to the compliance component 570 when processing by the compliance component 570 is to be performed.

The compliance component 570 may be configured to determine whether an output of the language model 545 is appropriate for output to the user 505. In some embodiments, the compliance component 570 may be configured to process language model output (e.g., the LM response 646) representing outputs/tokens generated by the language model 545 during processing of the user input data 527. The model output may include tokens generated during the task generation stage, the action generation stage or the response generation stage. The compliance component 525 may also or instead determine whether an input to the language model 545 (e.g., a user request, an output of another system component of the system 100) is appropriate and/or that the input will result in the language model 545 generating an output that is appropriate to present to the user 505. For this determination, the compliance component 570 may process the user input data 527 or a portion or representation thereof. In some embodiments, the compliance component 570 may process other data (e.g., context data, user profile data, system configuration/policy data, etc.) to determine whether the generated response and/or the input is appropriate.

In some embodiments, the compliance component 570 may determine whether the model output/LM response 646 and/or the user input data 527 corresponds to training data used to configure the language model 545 (e.g., the model output or user input is semantically or lexically similar to the training data, the model output or user input corresponds to functionality (e.g., topics, categories, actions, etc.) that the model is trained for, etc.). Additionally or alternatively, the compliance component 570 may determine whether the model output/LM response 646 and/or the user input data 527 corresponds to one or more words or phrases determined to be confidential, sensitive, or offensive. Additionally or alternatively, the compliance component 570 may determine whether the user input or the model output corresponds to an inappropriate content category, which may include biased content (e.g., biased toward protected classes including gender, race, age, etc.), harmful content (e.g., violent content, self-harm, etc.), profanity, etc.

In some embodiments, the compliance component 570 may use one or more techniques to determine whether the model output or the user input is appropriate; such techniques may include a rules-engine, a word-based similarity determination, a machine learning model based determination (e.g., using a classifier to classify model output or user input to appropriate category or inappropriate category), etc.

In some embodiments, the compliance component 570 may process the user input data 527 when it is received by the language model orchestrator component 530 and in some cases may process in parallel to the language model orchestrator component 530. In some embodiments, the compliance component 570 may process the model output as the language model 545 generates the output tokens. In other embodiments, the compliance component 570 may process the model output after the language model 545 has generated tokens for a particular processing stage (e.g., after the task generation stage is completed, after the action generation stage is completed, after the response generation stage is completed, etc.).

If the compliance component 570 determines that the model output or the user input data 527 is appropriate, then the language model orchestrator component 530 may continue processing with respect to the user input data 527. If the compliance component 570 determines that the model output is not appropriate, then one or more remedial actions may be performed.

One example remedial action may involve prompting the language model 545 to generate a new/modified model output. In such examples, additional prompt data may be determined, which may include the original prompt data, the initial model output, and an indication that the initial model output is not appropriate for output to the user 505. The additional prompt data may include a request or directive to the language model 545 to generate model output that is appropriate for output to the user 505. Another example remedial action may involve the system outputting a generic/template response (e.g., “Sorry, I can't help you with that” or “I cannot answer questions for [inappropriate category])”) or a request for a rephrased input (e.g., “can you rephrase that”).

In some embodiments, the compliance component 570 may cause the system to output a response indicating where (e.g., a source external to the system components 520) the included/outputted information may be found. For example, the response may include an indication of a source of the training data or the data (e.g., API response 662) that the response is based on (e.g., the indication may include a description of an owner of the intellectual property rights corresponding to the training data/the response information, a hyperlink to the source, etc.). In some embodiments the compliance component 570 may determine that the model generated response is based on (e.g., summarizing, using, similar to, etc.) data that protected by intellectual property rights (or other laws), and instead of outputting the language model generated response (e.g., LM response 646). In some embodiments the responsive output data 562 may include an indication of the intellectual property rights owner, may include access to a source of the data (e.g., website link), or may include a template response (e.g., “I cannot process this request” or “The requested data is protected by intellectual property rights”, etc.). In some embodiments, the compliance component 570 may determine that the user input data 527 involves processing data or outputting data that is protected by certain intellectual property rights (or other laws). An example of such a user input may be “write a story about [protected character]” or “draw an image of [protected character] doing [some action]”, where the owner of intellectual property rights in the [protected character] may not allow use, copying, or other operations. In response, the system may cease or prevent processing by the language model orchestrator 530 of the user input data 527, and the system may output a template response (e.g., “I cannot process this request”or “The requested data is protected by intellectual property rights”, etc.).

As shown in FIG. 5, the system component(s) 520 may include a personalized context component 565. In some embodiments, the personalized context component 565 may be included in the language model orchestrator component 530. In other embodiments, the personalized context component 565 may be one of the responding components 560 and the action plan generation component 550 may cause the action plan execution component 525 to send an API request to the personalized context component 565.

The personalized context component 565 may be configured to determine personalized context data including context data corresponding to the user input data 527 and/or the user 505. In some embodiments, the initial plan generation component 535 may request personalized context data to include in the prompt 642. In other embodiments, other system component(s) 520, such as the language model 545, may request personalized context data (e.g., to determine a personalized response to a user input). The personalized context data may include user preferences, past user inputs, past system outputs for past user inputs from the user 505, past skill/app usage, user-defined items, etc. The personalized context component 565 may infer user preferences from user-provided preferences, past user interactions by the user 505, information related to users similar to the user 505, etc. In some embodiments, the personalized context component 565 may employ one or more techniques to determine the personalized context data; such techniques may include using a rules-engine, using one or more machine learning models (including a generative model), topic determination techniques, neural retrieval search techniques, etc.

In examples, the personalized context component 565 may receive the user input data 527, task data representing a current task being performed/processed, and/or model output indicating that an ambiguity exists or additional information is needed to generate a response to the user input. The personalized context component 565 may receive a query in some examples, which may include an identifier for the user 505. In a non-limiting example, the personalized context component 565 may receive the following example requests: “Does the user prefer to use [Music Service 1] or [Music Service 2] for playing music,” or “What kind of music does the user like?” The personalized context component 565 determine example personalized context data including “The user prefers [Music Service 1]”or “The user likes [music genre]”).

Further information related to the SSG component 556 and the skill/app component 554 is described herein in relation to FIG. 7.

In some embodiments, the language model 545 may be fine-tuned to perform a particular task(s). Fine-tuning of the language model(s) may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks. Some techniques may involve supervised fine-tuning (SFT), unsupervised fine-tuning, semi-supervised fine-tuning, or other types of learning.

In some embodiments, one or more of the system components 520 described herein may be configured to begin processing with respect to data as soon as the data or a portion of the data is available to the components (e.g., processing in a streaming fashion). Some system components may be generative components/models that can begin processing with respect to portions of data as they are available, instead of waiting to initiate processing after the entirety of data is available. For example, the language model 545 may start processing a first portion of the prompt 642 while the prompt generation component 535 determines a second/subsequent portion of the prompt 642. As another example, the action plan generation component 550 may start processing a first portion of the LM response 646 while the language model 545 is generating a second/subsequent portion of the LM response 646.

The system 100 may operate using various components as described in FIG. 7. The various components may be located on same or different physical devices. Communication between various components may occur directly or across a network(s) 199. The user device 510 may include audio capture component(s), such as a microphone or array of microphones of a user device 510, captures audio 710 and creates corresponding audio data. Once speech is detected in audio data representing the audio 710, the user device 510 may determine if the speech is directed at the user device 510/system component(s). In at least some embodiments, such determination may be made using a wakeword detection component 720. The wakeword detection component 720 may be configured to detect various wakewords. In at least some examples, each wakeword may correspond to a name of a different digital assistant. An example wakeword/digital assistant name is “Alexa.” In another example, input to the system may be in form of text data 713, for example as a result of a user typing an input into a user interface of user device 510. Other input forms may include indication that the user has pressed a physical or virtual button on user device 510, the user has made a gesture, etc. The user device 510 may also capture images using camera(s) of the user device 510 and may send image data 721 representing those image(s) to the system component(s). The image data 721 may include raw image data or image data processed by the user device 510 before sending to the system component(s). The image data 721 may be used in various manners by different components of the system to perform operations such as determining whether a user is directing an utterance to the system, interpreting a user command, responding to a user command, etc. In some embodiments, the user input data 527 (described in relation to FIG. 5) may include one or more the audio 710, the audio data 711, the text data 713 and the image data 721.

The wakeword detection component 720 of the user device 510 may process the audio data, representing the audio 710, to determine whether speech is represented therein. The user device 510 may use various techniques to determine whether the audio data includes speech. In some examples, the user device 510 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the user device 510 may implement a classifier configured to distinguish speech from background noise. The classifier may be implemented by techniques such as linear classifiers, support vector machines, and decision trees. In still other examples, the user device 510 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 710, is analyzed to determine if specific characteristics of the audio data match preconfigured acoustic waveforms, audio signatures, or other data corresponding to a wakeword.

Thus, the wakeword detection component 720 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc.

There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 720 may be built on deep neural network (DNN)/recursive neural network (RNN) structures directly, without HMM being involved. Such an architecture may estimate the posteriors of wakewords with context data, either by stacking frames within a context window for DNN, or using an RNN. Follow-on posterior threshold tuning or smoothing is applied for decision making. Other techniques for wakeword detection, such as those known in the art, may also be used.

Once the wakeword is detected by the wakeword detection component 720 and/or input is detected by an input detector, the user device 510 may “wake” and begin transmitting audio data 711, representing the audio 710, to the system component(s) 520. The audio data 711 may include data corresponding to the wakeword; in other embodiments, the portion of the audio corresponding to the wakeword is removed by the user device 510 prior to sending the audio data 711 to the system component(s) 520. In the case of touch input detection or gesture-based input detection, the audio data may not include a wakeword.

In some implementations, the system 100 may include more than one system component(s). The system component(s) 520 may respond to different wakewords and/or perform different categories of tasks. Each system component(s) may be associated with its own wakeword such that speaking a certain wakeword results in audio data be sent to and processed by a particular system. For example, detection of the wakeword “Alexa” by the wakeword detection component 720 may result in sending audio data to system component(s) 520a for processing while detection of the wakeword “Computer” by the wakeword detector may result in sending audio data to system component(s) 520b for processing. The system may have a separate wakeword and system for different skills/systems (e.g., “Castle Adventure” for a game play skill/system component(s) 520c) and/or such skills/systems may be coordinated by one or more skill component(s) 554 of one or more system component(s) 520.

The user device 510/system component(s) 520 may also include a system directed input detector. The system directed input detector may be configured to determine whether an input to the system (for example speech, a gesture, etc.) is directed to the system or not directed to the system (for example directed to another user, etc.). The system directed input detector may work in conjunction with the wakeword detection component 720. If the system directed input detector determines an input is directed to the system, the user device 510 may “wake” and begin sending captured data for further processing. If data is being processed the user device 510 may indicate such to the user, for example by activating or changing the color of an illuminated output (such as a light emitting diode (LED) ring), displaying an indicator on a display (such as a light bar across the display), outputting an audio indicator (such as a beep) or otherwise informing a user that input data is being processed. If the system directed input detector determines an input is not directed to the system (such as a speech or gesture directed to another user) the user device 510 may discard the data and take no further action for processing purposes. In this way the system 100 may prevent processing of data not directed to the system, thus protecting user privacy. As an indicator to the user, however, the system may output an audio, visual, or other indicator when the system directed input detector is determining whether an input is potentially device directed. For example, the system may output an orange indicator while considering an input and may output a green indicator if a system directed input is detected. Other such configurations are possible.

Upon receipt by the system component(s) 520, the audio data 711 may be sent to an orchestrator component 730 and/or the language model orchestrator component 530. The orchestrator component 730 may include memory and logic that enables the orchestrator component 730 to transmit various pieces and forms of data to various components of the system, as well as perform other operations as described herein. In some embodiments, the orchestrator component 730 may optionally be included in the system component(s) 520. In embodiments where the orchestrator component 730 is not included in the system component(s) 520, the audio data 711 may be sent directly to the language model orchestrator component 530. Further, in such embodiments, each of the components of the system component(s) 520 may be configured to interact with the language model orchestrator component 530, the action plan execution component 525, the API provider component, and/or other component(s).

In some embodiments, the system component(s) 520 may include an arbitrator component 782, which may be configured to determine whether the orchestrator component 730 and/or the language model orchestrator component 530 are to process with respect to user input data. In some embodiments, the language model orchestrator component 530 may be selected to process with respect to the audio data 711 only if the user 505 associated with the audio data 711 (or the user device 510 that captured the audio 710) has previously indicated that the language model orchestrator component 530 may be selected to process with respect to user inputs received from the user 505.

In some embodiments, the arbitrator component 782 may determine the orchestrator component 730 and/or the language model orchestrator component 530 are to process with respect to the audio data 711 based on metadata associated with the audio data 711. For example, the arbitrator component 782 may be a classifier configured to process a natural language representation of the audio data 711 (e.g., output by the ASR component 750) and classify the corresponding user input as to be processed by the orchestrator component 730 and/or the language model orchestrator component 530. For further example, the arbitrator component 782 may determine whether the device from which the audio data 711 is received is associated with an indicator representing the audio data 711 is to be processed by the orchestrator component 730 and/or the language model orchestrator component 530. As an even further example, the arbitrator component 782 may determine whether the user (e.g., determined using data output from the user recognition component 795) from which the audio data 711 is received is associated with a user profile including an indicator representing the audio data 711 is to be processed by the orchestrator component 730 and/or the language model orchestrator component 530. As another example, the arbitrator component 782 may determine whether the audio data 711 (or the output of the ASR component 750) corresponds to a request representing that the audio data 711 is to be processed by the orchestrator component 730 and/or the language model orchestrator component 530 (e.g., a request including “let's chat” may represent that the audio data 711 is to be processed by the language model orchestrator component 530).

In some embodiments, if the arbitrator component 782 is unsure (e.g., a confidence score corresponding to whether the orchestrator component 730 and/or the language model orchestrator component 530 is to process is below a threshold), then the arbitrator component 782 may send the audio data 711 to both of the orchestrator component 730 and the language model orchestrator component 530. In such embodiments, the orchestrator component 730 and/or the language model orchestrator component 530 may include further logic for determining further confidence scores during processing representing whether the orchestrator component 730 and/or the language model orchestrator component 530 should continue processing, as is discussed further herein below.

The arbitrator component 782 may send the audio data 711 to an ASR component 750. In some embodiments, the component selected to process the audio data 711 (e.g., the orchestrator component 730 and/or the language model orchestrator component 530) may send the audio data 711 to the ASR component 750. The ASR component 750 may transcribe the audio data 711 into text data. The text data output by the ASR component 750 represents one or more than one (e.g., in the form of an N-best list) ASR hypotheses representing speech represented in the audio data 711. The ASR component 750 interprets the speech in the audio data 711 based on a similarity between the audio data 711 and pre-established language models. For example, the ASR component 750 may compare the audio data 711 with models for sounds (e.g., acoustic units such as phonemes, senons, phones, etc.) and sequences of sounds to identify words that match the sequence of sounds of the speech represented in the audio data 711. The ASR component 750 sends the text data generated thereby to the arbitrator component 782, the orchestrator component 730, and/or the language model orchestrator component 530. In instances where the text data is sent to the arbitrator component 782, the arbitrator component 782 may send the text data to the component selected to process the audio data 711 (e.g., the orchestrator component 730 and/or the language model orchestrator component 530). The text data sent from the ASR component 750 to the arbitrator component 782, the orchestrator component 730, and/or the language model orchestrator component 530 may include a single top-scoring ASR hypothesis or may include an N-best list including multiple top-scoring ASR hypotheses. An N-best list may additionally include a respective score associated with each ASR hypothesis represented therein.

In some embodiments, the orchestrator component 730 may cause a NLU component (not shown) to perform processing with respect to the ASR data generated by the ASR component 750. The NLU component may attempt to make a semantic interpretation of the phrase(s) or statement(s) represented in the ASR data input therein by determining one or more meanings associated with the phrase(s) or statement(s) represented in the text data. The NLU component may determine an intent representing an action that a user desires be performed and may determine information that allows a device (e.g., the device 510, the system component(s) 520, a skill/app component 554, a skill system component(s) 725, etc.) to execute the intent.

For example, if the ASR data corresponds to “play the 5th Symphony by Beethoven,” the NLU component may determine an intent that the system output music and may identify “Beethoven” as an artist/composer and “5th Symphony” as the piece of music to be played. For further example, if the ASR data corresponds to “what is the weather,” the NLU component may determine an intent that the system output weather information associated with a geographic location of the device 510. In another example, if the ASR data corresponds to “turn off the lights,” the NLU component may determine an intent that the system turn off lights associated with the device 510 or the user 505. However, if the NLU component is unable to resolve the entity—for example, because the entity is referred to by anaphora such as “this song” or “my next appointment”—the system can send a decode request to another speech processing system for information regarding the entity mention and/or other context related to the utterance. The natural language processing system may augment, correct, or base results data upon the ASR data as well as any data received from the system.

The NLU component may return NLU results data (which may include tagged text data, indicators of intent, etc.) back to the orchestrator component 730. The orchestrator component 730 may forward the NLU results data to a skill component(s) 554. If the NLU results data includes a single NLU hypothesis, the NLU component and the orchestrator component 730 may direct the NLU results data to the skill component(s) 554 associated with the NLU hypothesis. If the NLU results data includes an N-best list of NLU hypotheses, the NLU component and the orchestrator component 730 may direct the top scoring NLU hypothesis to a skill component(s) 554 associated with the top scoring NLU hypothesis. The system may also include a post-NLU ranker which may incorporate other information to rank potential interpretations determined by the NLU component.

In some embodiments, after determining that the orchestrator component 730 and/or the language model orchestrator component 530 should process with respect to the user input, the arbitrator 782 may be configured to periodically determine whether the orchestrator component 730 and/or the language model orchestrator component 530 should continue processing with respect to the user input. For example, after a particular point in the processing of the orchestrator component 730 (e.g., after performing NLU, prior to determining a skill component 554 to process with respect to the user input, prior to performing an action responsive to the user input, etc.) and/or the language model orchestrator component 530 (e.g., after selecting a task to be completed, after receiving the action response data from the one or more components, after completing a task, prior to performing an action responsive to the user input, etc.) the orchestrator component 730 and/or the language model orchestrator component 530 may query the arbitrator component 782 has determined that the orchestrator component 730 and/or the language model orchestrator component 530 should halt processing with respect to the user input. As discussed above, the system 100 may be configured to stream portions of data associated with processing with respect to a user input to the one or more components such that the one or more components may begin performing their configured processing with respect to that data as soon as it is available to the one or more components. As such, the arbitrator component 782 may cause the orchestrator component 730 and/or the language model orchestrator component 530 to begin processing with respect to a user input as soon as a portion of data associated with the user input is available (e.g., the ASR data, context data, output of the user recognition component 795. Thereafter, once the arbitrator component 782 has enough data to perform the processing described herein above to determine whether the orchestrator component 730 and/or the language model orchestrator component 530 is to process with respect to the user input, the arbitrator component 782 may inform the corresponding component (e.g., the orchestrator component 730 and/or the language model orchestrator component 530) to continue/halt processing with respect to the user input at one of the logical checkpoints in the processing of the orchestrator component 730 and/or the language model orchestrator component 530.

A skill system component(s) 725 may communicate with a skill/app component(s) 554 within the system component(s) 520 directly with the orchestrator component 730 and/or the action plan execution component 525, or with other components. A skill system component(s) 725 may be configured to perform one or more actions. An ability to perform such action(s) may sometimes be referred to as a “skill.” That is, a skill may enable a skill system component(s) 725 to execute specific functionality in order to provide data or perform some other action requested by a user. For example, a weather service skill may enable a skill system component(s) 725 to provide weather information to the system component(s) 520, a car service skill may enable a skill system component(s) 725 to book a trip with respect to a taxi or ride sharing service, an order pizza skill may enable a skill system component(s) 725 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system component(s) 520 may be configured with a skill/app component 554 dedicated to interacting with the skill system component(s) 725. Unless expressly stated otherwise, reference to a skill, skill device, or skill component may include a skill/app component 554 operated by the system component(s) 520 and/or skill/app operated by the skill system component(s) 725. Moreover, the functionality described herein as a skill or skill may be referred to using many different terms, such as an action, bot, app, or the like. The skill component 554 and or skill system component(s) 725 may return output data to the orchestrator component 730.

The system component(s) 520 may include the user knowledge determination component 115. The language model orchestrator 530 may be communicate (e.g., invoke, send a request, etc.) with the user knowledge determination component 115 as described herein. The orchestrator 730 may also communicate with the user knowledge determination component 115 for similar operations/actions. For example, the orchestrator 730 may send dialog data to the user knowledge determination component 115 for processing based on the NLU component (or another system component) determining that a user input(s) corresponds to a “learning opportunity”, a user request for the system to “learn” personalized user knowledge, etc. As further example, the orchestrator 730 (or another system component) may retrieve user knowledge from the user knowledge data storage 130 for performing processing using personalized user knowledge (e.g., incorporating personalized user knowledge in ASR processing, in NLU processing, skill selection, etc.).

The system component(s) 520 includes a SSG component 556. The SSG component 556 may generate audio data (e.g., synthesized speech) from text data, text embeddings, text tokens, audio tokens, audio embeddings, etc., using one or more different methods. Data input to the SSG component 556 may come from a skill/app component 554, the orchestrator component 730, the action plan execution component 525, or another component of the system. In one method of synthesis called unit selection, the SSG component 556 matches data against a database of recorded speech. The SSG component 556 selects matching units of recorded speech and concatenates the units together to form audio data. In another method of synthesis called parametric synthesis, the SSG component 556 varies parameters such as frequency, volume, and noise to create audio data including an artificial speech waveform. Parametric synthesis uses a computerized voice generator, sometimes called a vocoder.

The user device 510 may include still image and/or video capture components such as a camera or cameras to capture one or more images. The user device 510 may include circuitry for digitizing the images and/or video for transmission to the system component(s) 520 as image data. The user device 510 may further include circuitry for voice command-based control of the camera, allowing a user 505 to request capture of image or video data. The user device 510 may process the commands locally or send audio data 711 representing the commands to the system component(s) 520 for processing, after which the system component(s) 520 may return output data that can cause the user device 510 to engage its camera.

The system component(s) 520/the user device 510 may include a user recognition component 795 that recognizes one or more users using a variety of data. However, the disclosure is not limited thereto, and the user device 510 may include the user recognition component 795 instead of and/or in addition to the system component(s) 520 without departing from the disclosure.

The user recognition component 795 may take as input the audio data 711 and/or text data output by the ASR component 750. The user recognition component 795 may perform user recognition by comparing audio characteristics in the audio data 711 to stored audio characteristics of users. The user recognition component 795 may also perform user recognition by comparing biometric data (e.g., fingerprint data, iris data, etc.), received by the system in correlation with the present user input, to stored biometric data of users assuming user permission and previous authorization. The user recognition component 795 may further perform user recognition by comparing image data (e.g., including a representation of at least a feature of a user), received by the system in correlation with the present user input, with stored image data including representations of features of different users. The user recognition component 795 may perform additional user recognition processes, including those known in the art.

The user recognition component 795 determines scores indicating whether user input originated from a particular user. For example, a first score may indicate a likelihood that the user input originated from a first user, a second score may indicate a likelihood that the user input originated from a second user, etc. The user recognition component 795 also determines an overall confidence regarding the accuracy of user recognition operations.

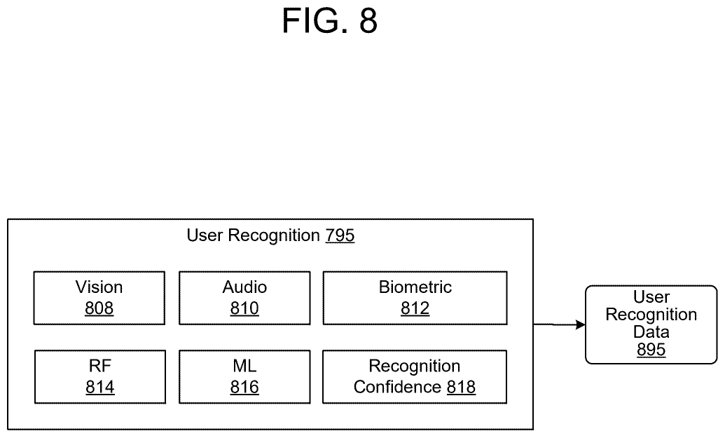

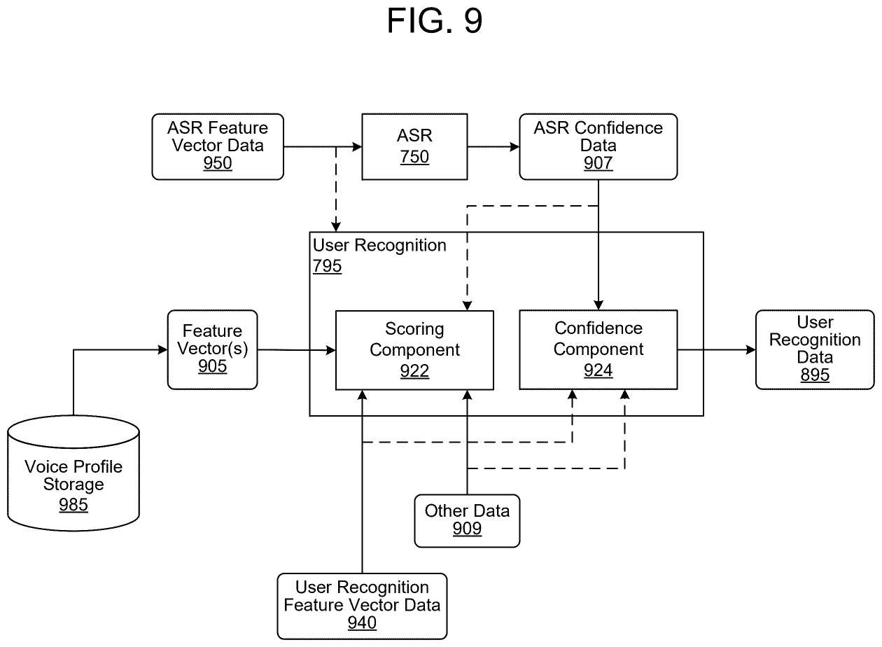

Output of the user recognition component 795 may include a single user identifier corresponding to the most likely user that originated the user input. Alternatively, output of the user recognition component 795 may include an N-best list of user identifiers with respective scores indicating likelihoods of respective users originating the user input. The output of the user recognition component 795 may be used to inform processing of the arbitrator component 782, the orchestrator component 730, and/or the language model orchestrator component 530 as well as processing performed by other components of the system. Further details of the user recognition component 795 are described in relation to FIGS. 8 and 9.

The system component(s) 520/user device 510 may include a presence detection component that determines the presence and/or location of one or more users using a variety of data.

The system 100 (either on user device 510, system component(s), or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc. ; input and output capabilities of the device; internet connectivity information; user bibliographic information; subscription information, as well as other information.

The profile storage 770 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more internet protocol (IP) addresses, medium access control (MAC) addresses, and/or device identifiers, such as a serial number, of each additional electronic device associated with the identified user account. When a user logs into to an application installed on a user device 510, the user profile (associated with the presented login information) may be updated to include information about the user device 510, for example with an indication that the device is currently in use. Each user profile may include identifiers of components (e.g., responding component(s) 560 such as skills/apps, language model-based agents, knowledge bases, components for a particular domain, etc.) that the user has enabled. When a user enables a component, the user is providing the system component(s) with permission to allow the component to execute with respect to the user's inputs. If a user does not enable a component, the system component(s) may not invoke that component to execute with respect to the user's inputs.

The profile storage 770 may include one or more group profiles. Each group profile may be associated with a different group identifier. A group profile may be specific to a group of users. That is, a group profile may be associated with two or more individual user profiles.

For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 770 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

Although the components of FIG. 7 may be illustrated as part of system component(s) 520, user device 510, or otherwise, the components may be arranged in other device(s) (such as in user device 510 if illustrated in system component(s) 520 or vice-versa, or in other device(s) altogether) without departing from the disclosure.

In at least some embodiments, the system component(s) 520 may receive the audio data 711 from the user device 510, to recognize speech corresponding to a spoken input in the received audio data 711, and to perform functions in response to the recognized speech. In at least some embodiments, these functions involve sending directives (e.g., commands), from the system component(s) to the user device 510 (and/or other user devices 510) to cause the user device 510 to perform an action, such as output an audible response to the spoken input via a loudspeaker(s), and/or control secondary devices in the environment by sending a control command to the secondary devices.

Thus, when the user device 510 is able to communicate with the system component(s) over the network(s) 199, some or all of the functions capable of being performed by the system component(s) may be performed by sending one or more directives over the network(s) 199 to the user device 510, which, in turn, may process the directive(s) and perform one or more corresponding actions. For example, the system component(s), using a remote directive that is included in response data (e.g., a remote response), may direct the user device 510 to output an audible response (e.g., using SSG processing performed by an on-device SSG component) to a user's question via a loudspeaker(s) of (or otherwise associated with) the user device 510, to output content (e.g., music) via the loudspeaker(s) of (or otherwise associated with) the user device 510, to display content on a display of (or otherwise associated with) the user device 510, and/or to send a directive to a secondary device (e.g., a directive to turn on a smart light). It is to be appreciated that the system component(s) may be configured to provide other functions in addition to those discussed herein, such as, without limitation, providing step-by-step directions for navigating from an origin location to a destination location, conducting an electronic commerce transaction on behalf of the user 505 as part of a shopping function, establishing a communication session (e.g., a video call) between the user 505 and another user, and so on.

In at least some embodiments, the user device 510, may send the audio data 711 to the wakeword detection component 720. If the wakeword detection component 720 detects a wakeword in the audio data 711, the wakeword detection component 720 may send an indication of such detection to the user device 510. In response to receiving the indication, the audio data 711 may be sent to the system component(s) 520 and/or the ASR component of the user device 510. The wakeword detection component 720 may also send an indication, to the user device 510, representing a wakeword was not detected. In response to receiving such an indication, the audio data 711 may not be sent to the system component(s) 520, and the user device 510 may prevent the ASR component of the user device 510 from further processing the audio data 711. In this situation, the audio data 711 can be discarded.

In some embodiments, the user device 510 may include some or all of the components illustrated in FIG. 7 and/or discussed herein above with respect to the system component(s) 520. In other embodiments, the components illustrated in FIG. 7 and/or discussed herein with respect to the system component(s) 520 may be distributed across the user device 510 and the system component(s) 520.

In at least some embodiments, the components of the user device 510 (e.g., on-device components) may not have the same capabilities as the components of the system component(s) 520. For example, on-device components may be configured to generate a response to only a subset of the natural language user inputs that may be handled by the system component(s) 520. For example, such subset of natural language user inputs may correspond to local-type natural language user inputs, such as those controlling devices or components associated with a user's home. In such circumstances the on-device components may be able to more quickly interpret and respond to a local-type natural language user input, for example, than processing that involves the system component(s). If the user device 510 attempts to process a natural language user input for which the on-device components are not necessarily best suited, the language processing results determined by the user device 510 may indicate a low confidence or other metric indicating that the processing by the user device 510 may not be as accurate as the processing done by the system component(s) 520.

In some embodiments, the system component(s) 520 and the user device 510 may process as described herein to generate responses to the user input corresponding to the audio data 711. The system component(s) 520 may send the response to the user device 510 and the user device 510 may determine whether to output the response generated by the system component(s) 520 or the response generated by the user device 510. In some embodiments, the system component(s) 520 may be configured to perform a portion of the processing described herein, such as a portion of processing not performable by the user device 510 and send the result of such processing to the user device 510. The user device 510 may be configured to determine whether to use the result to complete processing to generate the response to the user device 510.

In at least some embodiments, the user device 510 may include, or be configured to use, one or more skill/app components that may operate similarly to the skill /pp component(s) 554. The skill /pp component(s) on the user device 510 may correspond to one or more domains that are used in order to determine how to act on a spoken input in a particular way, such as by outputting a directive that corresponds to the determined intent, and which can be processed to implement the desired operation. The skill component(s) installed on the user device 510 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally, or alternatively, the user device 510 may be in communication with one or more skill system component(s) 725. For example, a skill system component(s) 725 may be located in a remote environment (e.g., separate location) such that the user device 510 may only communicate with the skill system component(s) 725 via the network(s) 199. However, the disclosure is not limited thereto. For example, in at least some embodiments, a skill system component(s) 725 may be configured in a local environment (e.g., home server and/or the like) such that the user device 510 may communicate with the skill system component(s) 725 via a private network, such as a local area network (LAN).

The device 510 and/or the system component(s) 520 may include the user recognition component 795 that recognizes one or more users using a variety of data. As illustrated in FIG. 8, the user recognition component 795 may include one or more subcomponents including a vision component 808, an audio component 810, a biometric component 812, a radio frequency (RF) component 814, a machine learning (ML) component 816, and a recognition confidence component 818. In some instances, the user recognition component 795 may monitor data and determinations from one or more subcomponents to determine an identity of one or more users associated with data input to the device 510 and/or the system component(s) 520. The user recognition component 795 may output user recognition data 895, which may include a user identifier associated with a user the user recognition component 795 determines originated data input to the device 510 and/or the system component(s) 520. The user recognition data 895 may be used to inform processes performed by various components of the device 510 and/or the system component(s) 520.

The vision component 808 may receive data from one or more sensors capable of providing images (e.g., cameras) or sensors indicating motion (e.g., motion sensors). The vision component 808 can perform facial recognition or image analysis to determine an identity of a user and to associate that identity with a user profile associated with the user. In some instances, when a user is facing a camera, the vision component 808 may perform facial recognition and identify the user with a high degree of confidence. In other instances, the vision component 808 may have a low degree of confidence of an identity of a user, and the user recognition component 795 may utilize determinations from additional components to determine an identity of a user. The vision component 808 can be used in conjunction with other components to determine an identity of a user. For example, the user recognition component 795 may use data from the vision component 808 with data from the audio component 810 to identify what user's face appears to be speaking at the same time audio is captured by a device 510 the user is facing for purposes of identifying a user who spoke an input to the device 510 and/or the system component(s) 520.

The overall system of the present disclosure may include biometric sensors that transmit data to the biometric component 812. For example, the biometric component 812 may receive data corresponding to fingerprints, iris or retina scans, thermal scans, weights of users, a size of a user, pressure (e.g., within floor sensors), etc., and may determine a biometric profile corresponding to a user. The biometric component 812 may distinguish between a user and sound from a television, for example. Thus, the biometric component 812 may incorporate biometric information into a confidence level for determining an identity of a user. Biometric information output by the biometric component 812 can be associated with specific user profile data such that the biometric information uniquely identifies a user profile of a user.

The radio frequency (RF) component 814 may use RF localization to track devices that a user may carry or wear. For example, a user (and a user profile associated with the user) may be associated with a device. The device may emit RF signals (e.g., Wi-Fi, Bluetooth®, etc.). A device may detect the signal and indicate to the RF component 814 the strength of the signal (e.g., as a received signal strength indication (RSSI)). The RF component 814 may use the RSSI to determine an identity of a user (with an associated confidence level). In some instances, the RF component 814 may determine that a received RF signal is associated with a mobile device that is associated with a particular user identifier.

In some instances, a personal device (such as a phone, tablet, wearable or other device) may include some RF or other detection processing capabilities so that a user who speaks an input may scan, tap, or otherwise acknowledge his/her personal device to the device 510. In this manner, the user may “register” with the system 100 for purposes of the system 100 determining who spoke a particular input. Such a registration may occur prior to, during, or after speaking of an input.

The ML component 816 may track the behavior of various users as a factor in determining a confidence level of the identity of the user. By way of example, a user may adhere to a regular schedule such that the user is at a first location during the day (e.g., at work or at school). In this example, the ML component 816 would factor in past behavior and/or trends in determining the identity of the user that provided input to the device 510 and/or the system component(s) 520. Thus, the ML component 816 may use historical data and/or usage patterns over time to increase or decrease a confidence level of an identity of a user.

In at least some instances, the recognition confidence component 818 receives determinations from the various components 808, 810, 812, 814, and 816, and may determine a final confidence level associated with the identity of a user. In some instances, the confidence level may determine whether an action is performed in response to a user input. For example, if a user input includes a request to unlock a door, a confidence level may need to be above a threshold that may be higher than a threshold confidence level needed to perform a user request associated with playing a playlist or sending a message. The confidence level or other score data may be included in the user recognition data 895.

The audio component 810 may receive data from one or more sensors capable of providing an audio signal (e.g., one or more microphones) to facilitate recognition of a user. The audio component 810 may perform audio recognition on an audio signal to determine an identity of the user and associated user identifier. In some instances, aspects of device 510 and/or the system component(s) 520 may be configured at a computing device (e.g., a local server). Thus, in some instances, the audio component 810 operating on a computing device may analyze all sound to facilitate recognition of a user. In some instances, the audio component 810 may perform voice recognition to determine an identity of a user.

The audio component 810 may also perform user identification based on audio data 711 input into the device 510 and/or the system component(s) 520 for speech processing. The audio component 810 may determine scores indicating whether speech in the audio data 711 originated from particular users. For example, a first score may indicate a likelihood that speech in the audio data 711 originated from a first user associated with a first user identifier, a second score may indicate a likelihood that speech in the audio data 711 originated from a second user associated with a second user identifier, etc. The audio component 810 may perform user recognition by comparing speech characteristics represented in the audio data 711 to stored speech characteristics of users (e.g., stored voice profiles associated with the device 510 that captured the spoken user input).

FIG. 9 illustrates user recognition processing as may be performed by the user recognition component 795. The ASR component 750 performs ASR processing on ASR feature vector data 950. ASR confidence data 907 may be passed to the user recognition component 795.

The user recognition component 795 performs user recognition using various data including the user recognition feature vector data 940, feature vectors 905 representing voice profiles of users of the system 100, the ASR confidence data 907, and other data 909. The user recognition component 795 may output the user recognition data 895, which reflects a certain confidence that the user input was spoken by one or more particular users. The user recognition data 895 may include one or more user identifiers (e.g., corresponding to one or more voice profiles). Each user identifier in the user recognition data 895 may be associated with a respective confidence value, representing a likelihood that the user input corresponds to the user identifier. A confidence value may be a numeric or binned value.

The feature vector(s) 905 input to the user recognition component 795 may correspond to one or more voice profiles. The user recognition component 795 may use the feature vector(s) 905 to compare against the user recognition feature vector 940, representing the present user input, to determine whether the user recognition feature vector 940 corresponds to one or more of the feature vectors 905 of the voice profiles. Each feature vector 905 may be the same size as the user recognition feature vector 940.

To perform user recognition, the user recognition component 795 may determine the device 510 from which the audio data 711 originated. For example, the audio data 711 may be associated with metadata including a device identifier representing the device 510. Either the device 510 or the system component(s) 520 may generate the metadata. The system 100 may determine a group profile identifier associated with the device identifier, may determine user identifiers associated with the group profile identifier, and may include the group profile identifier and/or the user identifiers in the metadata. The system 100 may associate the metadata with the user recognition feature vector 940 produced from the audio data 711. The user recognition component 795 may send a signal to voice profile storage 985, with the signal requesting only audio data and/or feature vectors 905 (depending on whether audio data and/or corresponding feature vectors are stored) associated with the device identifier, the group profile identifier, and/or the user identifiers represented in the metadata. This limits the universe of possible feature vectors 905 the user recognition component 795 considers at runtime and thus decreases the amount of time to perform user recognition processing by decreasing the amount of feature vectors 905 needed to be processed. Alternatively, the user recognition component 795 may access all (or some other subset of) the audio data and/or feature vectors 905 available to the user recognition component 795. However, accessing all audio data and/or feature vectors 905 will likely increase the amount of time needed to perform user recognition processing based on the magnitude of audio data and/or feature vectors 905 to be processed.

If the user recognition component 795 receives audio data from the voice profile storage 985, the user recognition component 795 may generate one or more feature vectors 905 corresponding to the received audio data.

The user recognition component 795 may attempt to identify the user that spoke the speech represented in the audio data 711 by comparing the user recognition feature vector 940 to the feature vector(s) 905. The user recognition component 795 may include a scoring component 922 that determines respective scores indicating whether the user input (represented by the user recognition feature vector 940) was spoken by one or more particular users (represented by the feature vector(s) 905). The user recognition component 795 may also include a confidence component 924 that determines an overall accuracy of user recognition processing (such as those of the scoring component 922) and/or an individual confidence value with respect to each user potentially identified by the scoring component 922. The output from the scoring component 922 may include a different confidence value for each received feature vector 905. For example, the output may include a first confidence value for a first feature vector 905a (representing a first voice profile), a second confidence value for a second feature vector 905b (representing a second voice profile), etc. Although illustrated as two separate components, the scoring component 922 and the confidence component 924 may be combined into a single component or may be separated into more than two components.

The scoring component 922 and the confidence component 924 may implement one or more trained machine learning models (such as neural networks, classifiers, etc.) as known in the art. For example, the scoring component 922 may use probabilistic linear discriminant analysis (PLDA) techniques. PLDA scoring determines how likely it is that the user recognition feature vector 940 corresponds to a particular feature vector 905. The PLDA scoring may generate a confidence value for each feature vector 905 considered and may output a list of confidence values associated with respective user identifiers. The scoring component 922 may also use other techniques, such as GMMs, generative Bayesian models, or the like, to determine confidence values.

The confidence component 924 may input various data including information about the ASR confidence 907, speech length (e.g., number of frames or other measured length of the user input), audio condition/quality data (such as signal-to-interference data or other metric data), fingerprint data, image data, or other factors to consider how confident the user recognition component 795 is with regard to the confidence values linking users to the user input. The confidence component 924 may also consider the confidence values and associated identifiers output by the scoring component 922. For example, the confidence component 924 may determine that a lower ASR confidence 907, or poor audio quality, or other factors, may result in a lower confidence of the user recognition component 795. Whereas a higher ASR confidence 907, or better audio quality, or other factors, may result in a higher confidence of the user recognition component 795. Precise determination of the confidence may depend on configuration and training of the confidence component 924 and the model(s) implemented thereby. The confidence component 924 may operate using a number of different machine learning models/techniques such as GMM, neural networks, etc. For example, the confidence component 924 may be a classifier configured to map a score output by the scoring component 922 to a confidence value.

The user recognition component 795 may output user recognition data 895 specific to a one or more user identifiers. For example, the user recognition component 795 may output user recognition data 895 with respect to each received feature vector 905. The user recognition data 895 may include numeric confidence values (e.g., 0.0-1.0, 0-1000, or whatever scale the system is configured to operate). Thus, the user recognition data 895 may output an n-best list of potential users with numeric confidence values (e.g., user identifier 123-0.2, user identifier 234-0.8). Alternatively or in addition, the user recognition data 895 may include binned confidence values. For example, a computed recognition score of a first range (e.g., 0.0-0.33) may be output as “low,” a computed recognition score of a second range (e.g., 0.34-0.66) may be output as “medium,” and a computed recognition score of a third range (e.g., 0.67-1.0) may be output as “high.” The user recognition component 795 may output an n-best list of user identifiers with binned confidence values (e.g., user identifier 123—low, user identifier 234 high). Combined binned and numeric confidence value outputs are also possible. Rather than a list of identifiers and their respective confidence values, the user recognition data 895 may only include information related to the top scoring identifier as determined by the user recognition component 795. The user recognition component 795 may also output an overall confidence value that the individual confidence values are correct, where the overall confidence value indicates how confident the user recognition component 795 is in the output results. The confidence component 924 may determine the overall confidence value.

The confidence component 924 may determine differences between individual confidence values when determining the user recognition data 895. For example, if a difference between a first confidence value and a second confidence value is large, and the first confidence value is above a threshold confidence value, then the user recognition component 795 is able to recognize a first user (associated with the feature vector 905 associated with the first confidence value) as the user that spoke the user input with a higher confidence than if the difference between the confidence values were smaller.

The user recognition component 795 may perform thresholding to avoid incorrect user recognition data 895 being output. For example, the user recognition component 795 may compare a confidence value output by the confidence component 924 to a threshold confidence value. If the confidence value does not satisfy (e.g., does not meet or exceed) the threshold confidence value, the user recognition component 795 may not output user recognition data 895, or may only include in that data 895 an indicator that a user that spoke the user input could not be recognized. Further, the user recognition component 795 may not output user recognition data 895 until enough user recognition feature vector data 940 is accumulated and processed to verify a user above a threshold confidence value. Thus, the user recognition component 795 may wait until a sufficient threshold quantity of audio data of the user input has been processed before outputting user recognition data 895. The quantity of received audio data may also be considered by the confidence component 924.

The user recognition component 795 may be defaulted to output binned (e.g., low, medium, high) user recognition confidence values. However, such may be problematic in certain situations. For example, if the user recognition component 795 computes a single binned confidence value for multiple feature vectors 905, the system may not be able to determine which particular user originated the user input. In this situation, the user recognition component 795 may override its default setting and output numeric confidence values. This enables the system to determine a user, associated with the highest numeric confidence value, originated the user input.

The user recognition component 795 may use other data 909 to inform user recognition processing. A trained model(s) or other component of the user recognition component 795 may be trained to take other data 909 as an input feature when performing user recognition processing. Other data 909 may include a variety of data types depending on system configuration and may be made available from other sensors, devices, or storage. The other data 909 may include a time of day at which the audio data 711 was generated by the device 510 or received from the device 510, a day of a week in which the audio data audio data 711 was generated by the device 510 or received from the device 510, etc.

The other data 909 may include image data or video data. For example, facial recognition may be performed on image data or video data received from the device 510 from which the audio data 711 was received (or another device). Facial recognition may be performed by the user recognition component 795. The output of facial recognition processing may be used by the user recognition component 795. That is, facial recognition output data may be used in conjunction with the comparison of the user recognition feature vector 940 and one or more feature vectors 905 to perform more accurate user recognition processing.

The other data 909 may include location data of the device 510. The location data may be specific to a building within which the device 510 is located. For example, if the device 510 is located in user A's bedroom, such location may increase a user recognition confidence value associated with user A and/or decrease a user recognition confidence value associated with user B.

The other data 909 may include data indicating a type of the device 510. Different types of devices may include, for example, a smart watch, a smart phone, a tablet, and a vehicle. The type of the device 510 may be indicated in a profile associated with the device 510. For example, if the device 510 from which the audio data 711 was received is a smart watch or vehicle belonging to a user A, the fact that the device 510 belongs to user A may increase a user recognition confidence value associated with user A and/or decrease a user recognition confidence value associated with user B.

The other data 909 may include geographic coordinate data associated with the device 510. For example, a group profile associated with a vehicle may indicate multiple users (e.g., user A and user B). The vehicle may include a global positioning system (GPS) indicating latitude and longitude coordinates of the vehicle when the vehicle generated the audio data 711. As such, if the vehicle is located at a coordinate corresponding to a work location/building of user A, such may increase a user recognition confidence value associated with user A and/or decrease user recognition confidence values of all other users indicated in a group profile associated with the vehicle. A profile associated with the device 510 may indicate global coordinates and associated locations (e.g., work, home, etc.). One or more user profiles may also or alternatively indicate the global coordinates.

The other data 909 may include data representing activity of a particular user that may be useful in performing user recognition processing. For example, a user may have recently entered a code to disable a home security alarm. A device 510, represented in a group profile associated with the home, may have generated the audio data 711. The other data 909 may reflect signals from the home security alarm about the disabling user, time of disabling, etc. If a mobile device (such as a smart phone, Tile, dongle, or other device) known to be associated with a particular user is detected proximate to (for example physically close to, connected to the same Wi-Fi network as, or otherwise nearby) the device 510, this may be reflected in the other data 909 and considered by the user recognition component 795.

Depending on system configuration, the other data 909 may be configured to be included in the user recognition feature vector data 940 so that all the data relating to the user input to be processed by the scoring component 922 may be included in a single feature vector. Alternatively, the other data 909 may be reflected in one or more different data structures to be processed by the scoring component 922.

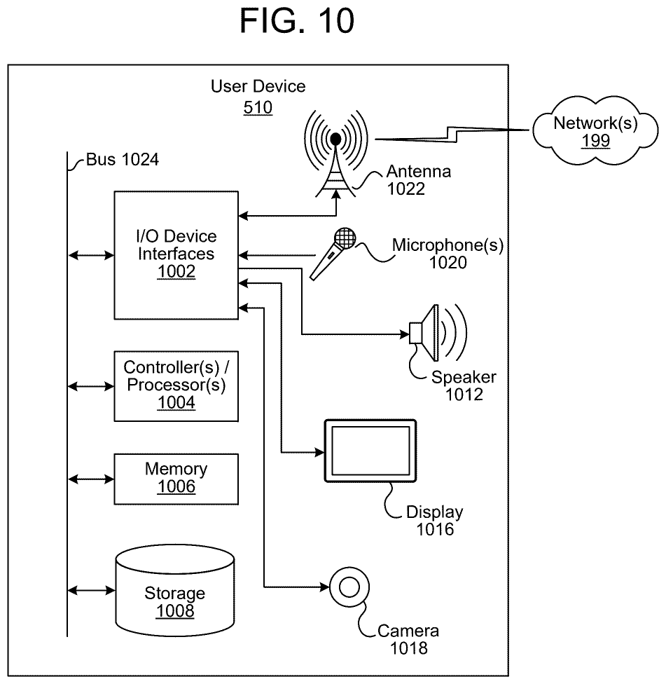

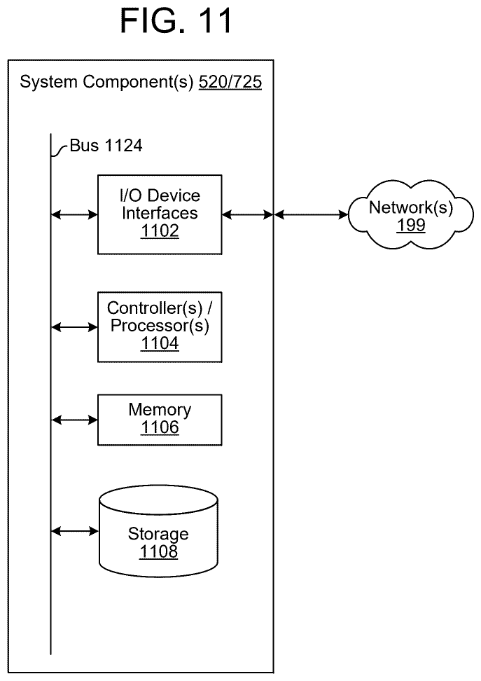

FIG. 10 is a block diagram conceptually illustrating a user device 510 that may be used with the system. FIG. 11 is a block diagram conceptually illustrating example components of a remote device, such as the system component(s) 520, which may assist with ASR processing, NLU processing, language model processing, etc., and a skill system component(s) 725. System component(s) (520/725) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the user device 510 may operate locally to a user (e.g., within a same environment so the device may receive inputs and playback outputs for the user) the server/system component(s) may be located remotely from the user device 510 as its operations may not require proximity to the user. The server/system component(s) may be located in an entirely different location from the user device 510 (for example, as part of a cloud computing system or the like) or may be located in a same environment as the user device 510 but physically separated therefrom (for example a home server or similar device that resides in a user's home or business but perhaps in a closet, basement, attic, or the like). The system component(s) 520 may also be a version of a user device 510 that includes different (e.g., more) processing capabilities than other user device(s) 510 in a home/office. One benefit to the server/system component(s) being in a user's home/business is that data used to process a command/return a response may be kept within the user's home, thus reducing potential privacy concerns.

Multiple system components (520/725) may be included in the overall system 100 of the present disclosure, such as one or more natural language processing system component(s) 520 for performing ASR processing, one or more natural language processing system component(s) 520 for performing NLU processing, one or more skill system component(s) 725, etc. In operation, each of these systems may include computer-readable and computer-executable instructions that reside on the respective device (520/725), as will be discussed further below.

Each of these devices (510/520/725) may include one or more controllers/processors (1004/1104), which may each include a central processing unit (CPU) for processing data and computer-readable instructions, and a memory (1006/1106) for storing data and instructions of the respective device. The memories (1006/1106) may individually include volatile random-access memory (RAM), non-volatile read only memory (ROM), non-volatile magnetoresistive memory (MRAM), and/or other types of memory. Each device (510/520/725) may also include a data storage component (1008/1108) for storing data and controller/processor-executable instructions. Each data storage component (1008/1108) may individually include one or more non-volatile storage types such as magnetic storage, optical storage, solid-state storage, etc. Each device (510/520/725) may also be connected to removable or external non-volatile memory and/or storage (such as a removable memory card, memory key drive, networked storage, etc.) through respective input/output device interfaces (1002/1102).

Computer instructions for operating each device (510/520/725) and its various components may be executed by the respective device's controller(s)/processor(s) (1004/1104), using the memory (1006/1106) as temporary “working” storage at runtime. A device's computer instructions may be stored in a non-transitory manner in non-volatile memory (1006/1106), storage (1008/1108), or an external device(s). Alternatively, some or all of the executable instructions may be embedded in hardware or firmware on the respective device in addition to or instead of software.

Each device (510/520/725) includes input/output device interfaces (1002/1102). A variety of components may be connected through the input/output device interfaces (1002/1102), as will be discussed further below. Additionally, each device (510/520/725) may include an address/data bus (1024/1124) for conveying data among components of the respective device. Each component within a device (510/520/725) may also be directly connected to other components in addition to (or instead of) being connected to other components across the bus (1024/1124).

Referring to FIG. 10, the user device 510 may include input/output device interfaces 1002 that connect to a variety of components such as an audio output component such as a speaker 1012, a wired headset or a wireless headset (not illustrated), or other component capable of outputting audio. The user device 510 may also include an audio capture component. The audio capture component may be, for example, a microphone 1020 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 510 may additionally include a display 1016 for displaying content. The user device 510 may further include a camera 1018.

Via antenna(s) 1022, the input/output device interfaces 1002 may connect to one or more networks 199 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (1002/1102) may also include communication components that allow data to be exchanged between devices such as different physical servers in a collection of servers or other components.

The components of the user device(s) 510, the system component(s) 520, or a skill system component(s) 725 may include their own dedicated processors, memory, and/or storage. Alternatively, one or more of the components of the user device(s) 510, the system component(s) 520, or a skill system component(s) 725 may utilize the I/O interfaces (1002/1102), processor(s) (1004/1104), memory (1006/1106), and/or storage (1008/1108) of the user device(s) 510, the system component(s) 520, or the skill system component(s) 725, respectively. Thus, the ASR component 750 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the user device 510, the system component(s) 520, and a skill system component(s) 725, as described herein, are illustrative, and may be located as a stand-alone device or may be included, in whole or in part, as a component of a larger device or system. As can be appreciated, a number of components may exist either as a system component(s) and/or on user device 510. Unless expressly noted otherwise, the system version of such components may operate similarly to the user device version of such components and thus the description of one version (e.g., the system version or the local user device version) applies to the description of the other version (e.g., the local user device version or system version) and vice-versa.

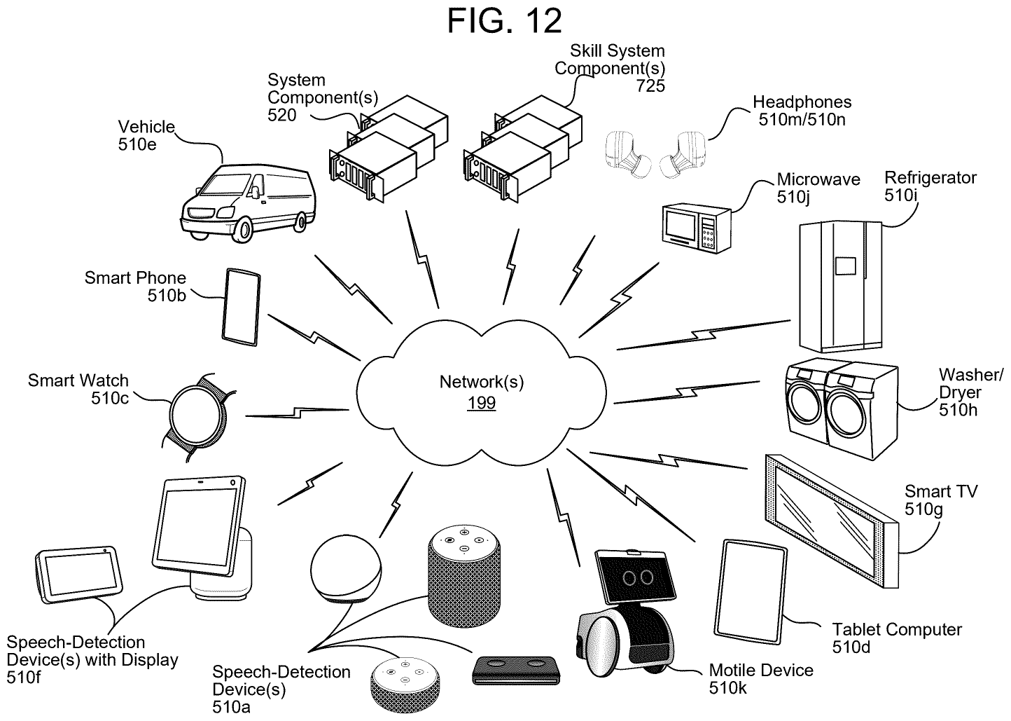

As illustrated in FIG. 12, multiple devices (510a-510n, 520, 725) may contain components of the system and the devices may be connected over a network(s) 199. The network(s) 199 may include a local or private network or may include a wide network such as the Internet. Devices may be connected to the network(s) 199 through either wired or wireless connections. For example, a speech-detection user device 510a, a smart phone 510b, a smart watch 510c, a tablet computer 510d, a vehicle 510e, a speech-detection device with display 510f, a display/smart television 510g, a washer/dryer 510h, a refrigerator 510i, a microwave 510j, autonomously motile user device 510k (e.g., a robot), headphones 510m/510n (e.g., wireless earbuds, wireless headphones), etc., may be connected to the network(s) 199 through a wireless service provider, over a Wi-Fi or cellular network connection, or the like. Other devices are included as network-connected support devices, such as the system component(s) 520, the skill system component(s) 725, and/or others. The support devices may connect to the network(s) 199 through a wired connection or wireless connection. Networked devices may capture audio using one-or-more built-in or connected microphones or other audio capture devices, with processing performed by components of the same device or another device connected via the network(s) 199, such as the system component(s) 520.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
receiving first dialog data associated with a user profile identifier, the first dialog data including at least a first natural language user input;
receiving first user knowledge data from storage, the first user knowledge data associated with the user profile identifier, and the first user knowledge data including first natural language data conveying a first affinity and second natural language data conveying a second affinity;
determining a first prompt including the first dialog data, the first user knowledge data, and a first request to determine updated user knowledge for the user profile identifier based at least in part on the first natural language user input and the first user knowledge data;
processing, using a first language model, the first prompt to generate second user knowledge data including:
the first natural language data, and
third natural language data conveying a modification of the second affinity, and
storing, in the storage, the second user knowledge data in association with the user profile identifier.

2. The computer-implemented method of claim 1, further comprising:
prior to receiving the first dialog data, causing presentation of a system output requesting information from a user associated with the user profile identifier;
in response to the system output, receiving a second natural language user input;
processing, using a second language model, the second natural language user input to generate action data indicating that the second natural language user input is to be processed to determine user knowledge data;
based on the action data, determining a second prompt including the second natural language user input and a second request to determine user knowledge for the user profile identifier based on the second natural language user input;
processing, using the first language model, the second prompt to generate the first user knowledge data; and
storing, in the storage, the first user knowledge data in association with the user profile identifier.

3. The computer-implemented method of claim 1, wherein the first dialog data includes a second natural language user input and the method further comprises:
determining that the second natural language user input includes a command for storing user knowledge data associated with the user profile identifier; and
based on the second natural language user input including the command, selecting the first dialog data for inclusion in the first prompt.

4. The computer-implemented method of claim 1, further comprising:
receiving second dialog data associated with the user profile identifier, the second dialog data including at least a second natural language user input;
determining, from the storage, the second user knowledge data associated with the user profile identifier;
determining a second prompt including the second dialog data, the second user knowledge data, and a second request to determine updated user knowledge for the user profile identifier based at least in part on the second natural language user input and the second user knowledge data;
processing, using the first language model, the second prompt to generate third user knowledge data excluding the first natural language data, the third user knowledge data including the third natural language data and fourth natural language data describing a third affinity; and
storing, in the storage, the third user knowledge data in association with the user profile identifier.

5. A computer-implemented method comprising:
receiving first dialog data associated with a user profile identifier;
determining first data representing at least first user knowledge associated with the user profile identifier;
determining a first prompt including a first request to determine at least second user knowledge based on the first dialog data and the first data;
processing, using a first generative model, the first prompt to generate second data representing at least the second user knowledge; and
storing third data associating the second data with the user profile identifier.

6. The computer-implemented method of claim 5, further comprising:
causing presentation of a system output requesting information from a user associated with the user profile identifier;
receiving the first dialog data in response to the system output; and
selecting the first dialog data for further processing based on the first dialog data being in response to the system output, wherein further processing includes determining the first prompt.

7. The computer-implemented method of claim 5, further comprising:
processing, using a second generative model, the first dialog data to determine that the first dialog data is to be selected for further processing, wherein further processing includes determining the first prompt.

8. The computer-implemented method of claim 5, further comprising:
receiving a set of commands corresponding to dialog data to be excluded from further processing;
determining that the first dialog data corresponds to a first command excluded from the set of commands; and
based on the first dialog data corresponding to the first command, selecting the first dialog data for further processing, wherein further processing includes determining the first prompt.

9. The computer-implemented method of claim 5, further comprising:
determining that the first dialog data corresponds to a command for updating user knowledge data associated with the user profile identifier; and
based on the first dialog data corresponding to the command, selecting the first dialog data for further processing, wherein further processing includes determining the first prompt.

10. The computer-implemented method of claim 5, wherein the first data includes an affinity,
wherein processing using the first generative model comprises generating the second user knowledge representing a modification to the affinity.

11. The computer-implemented method of claim 5, further comprising:
receiving image data corresponding to the first dialog data; and
determining the first prompt including the first request to determine at least the second user knowledge based on the first dialog data, the image data and the first data.

12. The computer-implemented method of claim 5, wherein receiving the first data comprises receiving the first data including first natural language data describing the first user knowledge, and
wherein the second data includes second natural language data describing the second user knowledge.

13. A system comprising:
at least one processor; and
at least one memory including instructions that, when executed by the at least one processor, cause the system to:
receive first dialog data associated with a user profile identifier;
determine first data representing at least first user knowledge associated with the user profile identifier;
determine a first prompt including a first request to determine at least second user knowledge based on the first dialog data and the first data;
process, using a first generative model, the first prompt to generate second data representing at least the second user knowledge; and
store third data associating the second data with the user profile identifier.

14. The system of claim 13, wherein the at least one memory includes further instructions that, when executed by the at least one processor, further cause the system to:
cause presentation of a system output requesting information from a user associated with the user profile identifier;
receive the first dialog data in response to the system output; and
select the first dialog data for further processing based on the first dialog data being in response to the system output, wherein further processing includes determining the first prompt.

15. The system of claim 13, wherein the at least one memory includes further instructions that, when executed by the at least one processor, further cause the system to:
process, using a second generative model, the first dialog data to determine that the first dialog data is to be selected for further processing, wherein further processing includes determining the first prompt.

16. The system of claim 13, wherein the at least one memory includes further instructions that, when executed by the at least one processor, further cause the system to:
receive a set of commands corresponding to dialog data to be excluded from further processing;
determine that the first dialog data corresponds to a first command excluded from the set of commands; and
based on the first dialog data corresponding to the first command, select the first dialog data for further processing, wherein further processing includes determining the first prompt.

17. The system of claim 13, wherein the at least one memory includes further instructions that, when executed by the at least one processor, further cause the system to:
determine that the first dialog data corresponds to a command for updating user knowledge data associated with the user profile identifier; and
based on the first dialog data corresponding to the command, select the first dialog data for further processing, wherein further processing includes determining the first prompt.

18. The system of claim 13, wherein the first data includes an affinity,
wherein processing using the first generative model comprises generating the second user knowledge representing a modification to the affinity.

19. The system of claim 13, wherein the at least one memory includes further instructions that, when executed by the at least one processor, further cause the system to:
receive image data corresponding to the first dialog data; and
determine the first prompt including the first request to determine at least the second user knowledge based on the first dialog data, the image data and the first data.

20. The system of claim 13, wherein receiving the first data comprises receiving the first data including first natural language data describing the first user knowledge, and
wherein the second data includes second natural language data describing the second user knowledge.
